(19) United States
(12) Patent Application Publication
(10) Pub. No.: US 2020/0266757 A1
(43) Pub. Date: Aug. 20, 2020

(54) Interlocking, Preassembled Solar Panel Module System and Installation Method

(71) Applicant: Smash Solar, Inc., Richmond, CA (US)

(72) Inventors: Neil Goldberg, Berkeley, CA (US); Troy Douglas Tyler, El Cerrito, CA (US); Eugene Kim, Orinda, CA (US); Bron Davis, Vacaville, CA (US); David Schultz, Berkeley, CA (US); Miguel Martinho Lopes Praca, Kentfield, CA (US); John Wolfe, Berkeley, CA (US)

(21) Appl. No.: 15/752,248

(22) PCT Filed: Aug. 11, 2016
(86) PCT No.: PCT/US16/46649

§ 371 Date: Feb. 12, 2018

Related U.S. Application Data
(60) Provisional application No. 62/326,811, filed on Apr. 24, 2016.
(60) Provisional application No. 62/321,467, filed on Apr. 12, 2016.
(60) Provisional application No. 62/260,321, filed on Nov. 26, 2015.
(60) Provisional application No. 62/209,860, filed on Aug. 25, 2015.
(60) Provisional application No. 62/203,902, filed on Aug. 11, 2015.

(51) Int. Cl. H02S 30/00; H02S 20/23

(52) U.S. Cl. CPC H02S 30/00; H02S 20/23

(57) ABSTRACT

A preassembled solar panel module includes a solar panel configured for receiving and converting solar radiation to produce electrical power. Multiple panel rails are coupled in preassembly to a backside surface of the solar panel, including at least two panel rails disposed halfway or more along opposing longest edges of the solar panel. Multiple snap connector components are each coupled to one of the at least two rails and are each configured to couple with a complementary snap connector component of an adjacent preassembled solar panel module. One or more mounting feet are each coupled at a selected location to one of the at least two panel rails and are each configured for coupling at a selected location to a roof or other sunlight receiving surface.

### PRIORITY AND RELATED APPLICATIONS

This application claims priority to U.S. provisional patent application Ser. No. 62/203,902, filed Aug. 11, 2015, which is incorporated by reference.

This application also claims priority to U.S. provisional patent application Ser. No. 62/209,860, filed Aug. 25, 2015; U.S. Ser. No. 62/260,321, filed Nov. 26, 2015; U.S. Ser. No. 62/321,467, filed Apr. 12, 2016; and U.S. Ser. No. 62/326,811, filed Apr. 24, 2016; which are each incorporated by reference.

This application is also a continuation-in-part (CIP) of PCT/US16/44151, filed Jul. 27, 2016, which claims priority to U.S. Ser. No. 62/197,564, filed Jul. 27, 2015, which are each incorporated by reference.

This application is also a CIP of U.S. Ser. No. 15/138,437, filed Apr. 26, 2016, which claims priority to U.S. Ser. No. 62/152,938, filed Apr. 26, 2015, which are each incorporated by reference.

This application is also a CIP of PCT/US2016/000019, filed Mar. 2, 2016, which claims priority to U.S. Ser. No. 62/127,287, filed Mar. 2, 2015, which are each incorporated by reference.

This application is also a CIP of U.S. Ser. No. 14/521,245, filed Oct. 22, 2014, which is a CIP of U.S. Ser. No. 14/054,807, filed Oct. 15, 2013, which claims priority to U.S. Ser. No. 61/712,878, filed Oct. 12, 2012, which are incorporated by reference.

### GOVERNMENT LICENSE RIGHTS

This invention was made with government support under the SunShot Financial Assistance Award number DE-EE0006457 awarded by the Department of Energy. The government has certain rights in the invention.

### BACKGROUND

Solar panels are widely used in the production of electricity with multiple panels typically connected together as panel assemblies. These solar panel assemblies are usually arranged in arrays and mounted on structural racking systems on the roofs of buildings, on the ground or other fixed structures. A fixed structure can include, but is not limited to, existing residential or commercial roof tops, horizontal surfaces or vertical surfaces, existing fences, railings, walls or open ground-mounted areas. In many jurisdictions, these mounting systems pass loading tests to ensure they can withstand static and dynamic loading anticipated during the life of the installation. These solar racking systems are often custom designed for each application and custom installed by contractors and tradespeople using specialty skills and following the approved drawings.

PV Solar modules typically are constructed using a lamination of a front sheet of glass, a layer of adhesive sealant, photovoltaic materials and conductors, another layer of adhesive and a sheet of specially designed polymer sheet, called the backsheet. These PV “glass-backsheet” modules are typically constructed with a frame to add rigidity to the “glass-backsheet” lamination and to provide a mounting point for the module.

In addition, a number of solar panel manufacturers have released new solar panels with integrated micro-inverters to simplify the electrical installation process. But a simple, low skill mechanical installation of a solar array remains unavailable on the market today.

Typical solar mounting or racking systems fail to provide the flexibility and ease of installation that many believe necessary for large scale adoption of solar power in the United States and around the world.

It is desired to have a solar module system that includes a flexible, configurable design that allows direct attachment either to the roof sheathing (plywood spanning over structural roof rafters or roof trusses that serves as a foundation for roofing materials) or to the roof rafters or roof trusses themselves. It is further desired to have a flexible, configurable solar module system that may be installed in a streamlined installation process which eliminates much if not all of the expense of custom design and installation activities. It is desired to have a solar module system that reduces work on the roof and reduces the skills and experience potentially necessary on the roof to perform a high quality solar array installation.

### BRIEF DESCRIPTION OF THE DRAWINGS

FIGS. 1-3 schematically illustrate partial top perspective views of example embodiments of a preassembled solar panel module including a mounting foot and snap connector components each coupled separately to one of multiple panel rails that are coupled to a backside surface of an otherwise frameless solar panel module.

FIG. 4 schematically illustrates a side view of the solar panel module of FIGS. 1-3.

FIG. 5 schematically illustrates a partial top perspective view of a preassembled solar panel module including a mounting foot and snap connector components coupled separately to a notched rail that is attached along one edge of the backside of an otherwise frameless preassembled solar panel module in accordance with certain embodiments.

FIGS. 6A-6B schematically illustrate backside views respectively of end and interior solar panel modules each having long and short panel rails that are coupled to a backside surface of the preassembled solar panel modules, wherein each of the solar panel modules of FIGS. 6A-6B also include snap connector brackets at each corner where the long and short panel rails meet and snap connector components attached at mid-rail locations to the long panel rails in accordance with certain embodiments.

FIG. 6C schematically illustrates panel rail architectures, snap connector brackets and mid-rail components, corner bumpers and mounting feet that are configured for coupling to a backside surface of a solar panel to form a preassembled solar panel module in accordance with an example embodiment.

FIG. 7 schematically illustrates a frontside view the interior solar panel module of FIG. 6B.

FIG. 8 schematically illustrate perspective, partial perspective, and side views, respectively, of the end solar panel module of FIG. 6A.

FIG. 9 schematically illustrates a top perspective view of a preassembled solar panel module in accordance with certain embodiments.

FIG. 10 schematically illustrates a bottom or backside view of a preassembled solar panel module including a pair of long panel rails and a pair of short panel rails coupled to a backside surface of the module in accordance with certain embodiments.

FIG. 11 schematically illustrates an exploded view of one of a pair of snap connector components including a rotational coupler lock in accordance with certain embodiments.

FIG. 12 schematically illustrates the other of said pair of snap connector components that complements the snap connector component of FIG. 11.

FIG. 13 schematically illustrates a female snap coupler component coupled with a rotational coupler lock in an open position in accordance with certain embodiments.

FIG. 14 schematically illustrates a male snap coupler component that is interconnected with the female snap coupler of FIG. 13 with the rotational coupler lock in the open position in accordance with certain embodiments.

FIG. 15 schematically illustrates an assembly of a female snap coupler and a complementary male snap coupler with the rotational coupler lock in the closed position in accordance with certain embodiments.

FIG. 16A schematically illustrates a section of a bottom view of a female snap coupler snap-coupled to a male snap coupler with the rotational coupler lock in the open (unlocked) position in accordance with certain embodiments.

FIG. 16B schematically illustrates a section of a bottom view of a female snap coupler snap coupled to a male snap coupler with the rotational coupler lock in a closed (locked) position.

FIGS. 17A-17I illustrate in several views a rotational coupler lock in accordance with certain embodiments that is movable between unlocked and locked positions.

FIG. 18 schematically illustrates an isometric of a full assembly of a height-adjustable module mounting foot for coupling a preassembled solar panel module to a sunlight receiving surface.

FIG. 19 schematically illustrates an exploded view of the height-adjustable mounting foot of FIG. 18.

FIGS. 20A-20B schematically illustrate end and perspective views of a panel rail or stiffener that is configured to coupling to a backside surface of a solar panel to form a preassembled solar panel module in accordance with certain embodiments.

FIGS. 21A-21B schematically illustrate end and perspective views of another panel rail or stiffener that is configured to coupling to a backside surface of a solar panel to form a preassembled solar panel module in accordance with certain embodiments.

FIGS. 22A-22B schematically illustrate a flashing with a conic protrusion in accordance with certain embodiments.

FIGS. 22C-22D schematically illustrate a flashing with a cylindrical or tubular protrusion in accordance with certain embodiments.

FIG. 23 schematically illustrates a section of a height adjustable mounting foot including an integrated rack and pinion mechanism coupled between an arm and an arm base for adjusting a height of a stiffener base, and thus for adjusting a height of a preassembled solar panel module having a stiffener or panel rail coupled to a backside thereof, from a sunlight receiving surface in accordance with certain embodiments.

FIG. 24 schematically illustrates a section of a height adjustable mounting foot including a pair of shoulder screws coupling multiple parts together in accordance with certain embodiments.

FIG. 25 schematically illustrates an exploded view of a height adjustable mounting foot that includes an arm base support between a modified arm base and a flashing base in accordance with certain embodiments.

FIG. 26 schematically illustrates an isometric view of a height adjustable mounting foot including an arm base support in accordance with certain embodiments.

FIG. 27 schematically illustrates a section of a height adjustable mounting foot including a flashing base and arm base support in accordance with certain embodiments.

FIG. 28 schematically illustrates a section of a height adjustable mounting foot including a flashing base and arm base support in accordance with certain embodiments.

FIG. 29 schematically illustrates a bottom perspective view of an solar panel alignment tool in accordance with certain embodiments.

FIG. 30 schematically illustrates the alignment tool of FIG. 29 about to be engaged with corners of three preassembled solar panel modules of a solar array in accordance with certain embodiments.

FIG. 31 schematically illustrates the alignment tool of FIGS. 29-30 engaged with a corner of each of three preassembled solar panel modules of a solar array in accordance with certain embodiments.

FIGS. 32A-32C schematically illustrate an alignment string mounting stand in accordance with certain embodiments.

FIGS. 33A-33B schematically illustrate application of an alignment string mounting stand in accordance with certain embodiments.

FIGS. 34-35 schematically illustrate a pair of engaged snap couplers including a slide lock that is in an unlocked position in accordance with certain embodiments.

FIGS. 36-37 schematically illustrate a pair of engaged snap couplers including a slide lock that is in a locked position in accordance with certain embodiments.

FIG. 38 schematically illustrates a pair of engaged snap couplers including a slide lock that is in an unlocked position in accordance with certain embodiments.

FIG. 39 schematically illustrates a section of a perspective view of a mounting foot.

FIG. 40 schematically illustrates an exploded view of jaw clamping mounting foot.

FIG. 41 is an exploded view of a jaw clamping assembly in accordance with certain embodiments.

### DETAILED DESCRIPTION OF THE EMBODIMENTS

An array of two or more preassembled solar panel modules is provided. Each preassembled solar panel module includes a solar panel configured for receiving and converting solar radiation to produce electrical power. Multiple panel rails are coupled in preassembly to backside surfaces of said solar panels, including at least two panel rails disposed halfway or more along opposing long edges of each solar panel. Multiple snap connector components are coupled to or integrated with the panel rails and protrude from proximate edges of adjacent preassembled solar panel modules at matching locations for snapping together said adjacent modules. The multiple snap connector components may include snap lock components that are each movable to a locked position to prevent decoupling of said adjacent modules after said snapping together of said adjacent modules. One or more mounting feet are each coupled both at a selected location to one of the at least two panel rails and at a selected location to a roof or other sunlight receiving surface upon which said array is installed.

The snap connector components may include a pair of flexible members including protrusions or defining recesses for matching a complementary snap connector component of an adjacent module for snapping together the adjacent modules. The snap-lock components may be configured to lock the snap connectors of adjacent modules together in a locked position by inhibiting flexing of the flexible members. The flexing may be inhibited by one or more slide-lock components occupying areas alongside the flexible members.

Snap-lock components may be rotatable or slidable between unlocked and locked positions. Mounting feet and/or snap connectors may be snap-coupled or snap-lock coupled to panel rails.

The mounting feet may be configured for height adjustment. The mounting feet may include a rack and pinion mechanism for height adjustment.

A height (H) to gap (G) ratio may be between 0.42<H/G<15. H may include a height of a preassembled solar panel module measured as a spacing of said backside surface of the preassembled solar panel module from the roof or other sunlight receiving surface. G may include a gap spacing between nearest edges of adjacent preassembled solar panel modules. The height to gap ratio H/G may be between 0.42<H/G<3, or between 0.42<H/G<1.5. The gap (G) may be between 20 mm<G<120 mm. The height (H) may be between 50 mm<H<300 mm. The height (H) may be 75 mm or less. The gap (G) may be 37.5 mm or more. The ratio H/G may be approximately 1.

Multiple wind deflectors may be coupled to sides of preassembled solar panel modules that each define a peripheral segment of the array.

One or more short panel rails may be coupled to the backside surface of one or more preassembled solar panel modules of the array disposed halfway or more along opposing shortest edges of the solar panel between the at least two panel rails that are disposed at opposing long edges.

Two or more short panel rails may be coupled to the backside surface of one or more preassembled solar panel modules of the array disposed halfway or more along short dimension segments spaced from either shortest edge of the solar panel between the at least two panel rails that are disposed at the opposing long edges.

Bumpers may be coupled at corners of the preassembled solar panel modules that extend normally from the backside surface further than any of the panel rails.

Bumpers may be coupled at corners of the preassembled solar panel modules that protrude from the backside surface away from both adjacent edges.

The at least two panel rails may include outer facing walls with one or more features for coupling with one or more complementary features of the mounting feet or of the snap connector components, or both, for preventing movement along the at least two panel rails by the mounting feet or by the snap connector components, or both. The one or more features may include a series of notches or recesses or both. The one or more features may include a series of cutouts and the one or more complementary features may include a series of protrusions.

The mounting feet may each include a slider and at least two panel rails may each include a flange that does not overlap the slider in a direction normal to the preassembled solar panel module when the slider is in an open position, thereby permitting receipt of a flange end of a panel rail within a rail receiving recess defined within each of the mounting feet, wherein the flange does overlap the slider in the direction normal to the preassembled solar panel module when the slider is slid to a closed position from an open position for securing the mounting feet to the at least two panel rails.

One or more snap connector components may include a slider for securing the snap connector components to the at least two panel rails.

One or more toggle anchors coupled to mounting feet may each include a rotatably-attached, elongated washer for piercing roof sheathing or other sunlight receiving surface material in a first position and rotating to a second position securing the toggle anchor after the piercing.

The solar panel may be framed or frameless. The framed or frameless solar panel may be strengthened by the panel rails being configured to stiffen the solar panel.

Adjacent solar panel modules may be coupled together by coupling together complementary snap connector components that are coupled one to each of two adjacent preassembled solar panel modules.

Adjacent preassembled solar panel modules may be relatively aligned by the coupling together of complementary snap connector components that are coupled one to each of the adjacent preassembled solar panel modules. Complementary snap connector components may include a locking mechanism to secure the coupling of the adjacent preassembled solar panel modules against snap decoupling.

Mounting feet may include one or more pivoting features configured to provide relative movement between a pair of components to prevent or reduce strain or stress within the array.

The mounting feet may include one or more pivoting features configured to provide relative movement of a preassembled solar panel module within the array to prevent or reduce stress or strain from wind or snow loading or other factors by flexing about the one or more pivoting features.

The mounting feet may be configured for height adjustment to a selected level among multiple levels. The mounting feet may include a rack and pinion mechanism for height adjustment to a selected level among multiple levels. The mounting feet may include a pair of height adjustment components, wherein at least one of the pair includes multiple matching recesses or protrusions or both corresponding to different levels of height adjustment. The mounting feet may include a threaded height adjustment component.

The mounting feet may include one or more pivoting features configured for relative movement between a pair of pivotably-coupled components to prevent or reduce strain or stress.

The solar panels may include two or more overlapping surfaces that are configured to receive and convert solar radiation to generate electrical power.

A preassembled solar panel module is provided that includes a solar panel configured for receiving and converting solar radiation to produce electrical power and one or more panel rails coupled in preassembly to a backside surface of the solar panel. Two or more panel rails may be disposed a quarter length or more along opposing longest edges of the solar panel. One or more flexible snap connector components may be coupled to each to one of the panel rails and configured for coupling with a complementary snap connector component of an adjacent preassembled solar panel module. One or more mounting feet may each be coupled at a selected location to a panel rail and each may be configured for coupling at a selected location to a roof or to another sunlight receiving surface.

One or two or more short panel rails may be coupled to the backside surface of the preassembled solar panel module disposed halfway or more along opposing shortest edges of the solar panel between two panel rails that are disposed at opposing long edges of the module.

A bumper may be coupled at each corner of the preassembled solar panel module that extends normally from the backside surface further than any panel rail.

The panel rails may include outer facing walls with a series of notches protruding therefrom for coupling with complementary notches of mounting feet and/or of snap connector components for preventing movement along the panel rails by the mounting feet and/or snap connector components.

The mounting feet may each include a slider and panel rails may each include a flange that does not overlap the slider in a direction normal to the preassembled solar panel module when the slider is in an open position, thereby permitting receipt of a flange end of a panel rail within a rail receiving recess defined within each of the mounting feet, wherein the flange does overlap the slider in the direction normal to the preassembled solar panel module when the slider is slid to a closed position from the open position for securing the mounting feet to the panel rails. One or more snap connector components may include a slider for securing the snap connector component to a panel rail.

One or more toggle anchors may each include a rotatably-attached, elongated washer for piercing roof sheathing or other sunlight receiving surface material in a first position and rotating to a second position securing the toggle anchor after the piercing.

The preassembled solar panel module may be frameless and strengthened by the panel rails being configured to stiffen said solar panel. The preassembled solar panel module may be configured for coupling with one or more adjacent preassembled solar panel modules by coupling together complementary snap connector components that are coupled to panels rails of adjacent preassembled solar panel modules.

Snap connector components may provide relative alignment with adjacent modules of an array by the coupling together of complementary snap connector components coupled one to each of the adjacent preassembled solar panel modules.

Snap connector components may include a locking mechanism to secure the coupling with a snap connector component of an adjacent preassembled solar panel module.

A method of installing an array of preassembled solar panel modules with precision alignment is provided, wherein the preassembled modules includes mounting feet and pairs of snap connectors that are coupled to panel rails or other components that are coupled to a backside surfaces of said modules, wherein the pairs of snap connectors are configured to protrude from proximate edges of adjacent preassembled solar panel modules. The method includes installing a first preassembled solar panel module to a roof or other sunlight receiving surface, including coupling multiple mounting feet that are coupled to a backside surface of the first module to a roof or other surface. A second preassembled solar panel module is then coupled to the first module, including snap coupling together one or more pairs of snap connectors protruding from proximate edges of the first and second modules at matching locations. The second solar panel is then installed to the roof or other surface in alignment with the first solar panel module, including coupling one or more mounting feet that are coupled to a backside surface of the second module to the roof or other surface.

Pairs of snap connectors may include spring-loaded pins configured to snap into complementary recesses defined within respective snap connector components of each pair and/or may include flexible members and catch features configured for snapping together adjacent preassembled solar panel modules. The method may include locking the snap connectors together to prevent snap decoupling after snapping them together. The locking of the snap connectors may include moving a snap-lock component to a locked position to prevent decoupling of adjacent modules after snapping them together. The moving of the snap lock component may include rotating and/or sliding a snap lock handle.

Mounting feet may be configured to structurally attach to a roof surface at any location without first locating roof structural members such as rafters.

The method may include anchoring four mounting feet of the first preassembled solar panel module to the roof or other sunlight receiving surface, and anchoring two mounting feet of the second preassembled solar panel module to the roof or other sunlight receiving surface, wherein the two mounting feet may be coupled to a panel rail or other backside component of the second preassembled solar panel module and may protrude from a distal edge opposite the proximate edge to the first preassembled solar panel module

Another method of installing an array of two or more preassembled solar panel modules with precision alignment is provided. The method includes mounting a first preassembled solar panel module to a sunlight receiving surface with two corners disposed a predetermined distance from an edge of an area of the sunlight receiving surface within which the array is being installed. A second preassembled solar panel module is then snap coupled to the first preassembled solar panel module. An alignment tool is then engaged between adjacent corners of the first and second modules. The second module is adjusted such that a corner opposite to the engaged alignment tool is disposed the same predetermined distance from the edge. The second module is then mounted to the sunlight receiving surface.

The alignment tool may include two or more corner plates, and the engaging the alignment tool may include receiving adjacent corners of the first and second modules at two of the corner plates. Each corner plate may include a pair of perpendicular plates including a first plate of a first corner plate that is coplanar with a first plate of second corner plate and a second plate of the first corner plate that is parallel to a second plate of the second corner plate, wherein the second plates are spaced apart a predetermined distance. The two corner plates may be configured to receive a corners of corner bumpers that are coupled to backside surfaces of the first and second modules.

Another method of installing an array of two or more preassembled solar panel modules with precision alignment is provided. The method includes coupling a pair of alignment string mounting stands to a sunlight receiving surface each disposed a predetermined distance from an edge of an area of the sunlight receiving surface within which the array is being installed. A taut line is coupled at each end to one of the pair of alignment string mounting stands. Multiple preassembled solar panel modules are installed in a row each with two corners disposed on the taut line or a predetermined distance from the taut line or otherwise aligned with the taut line.

The alignment string mounting stands may each include a base plate and one or more perpendicular plates that include one or more string mounting tabs and define one or more string holes. The method may include anchoring the taut line at each end to a mounting tab of one of the alignment string mounting stands, and elevating the taut line above the sunlight receiving surface including running the taut line through a string hole that is spaced a predetermined height above the sunlight receiving surface. The coupling the pair of alignment string mounting stands to the sunlight receiving surface may include tucking the base plate of each stand underneath spaced apart shingles or tiles of a shingle or tile roof.

The installing of multiple preassembled solar panel modules may include snap coupling adjacent modules and adjusting a position of one or more of the snap couplers along an edge of a module to align the module with the taut line.

### Framed or Frameless Solar Panels

In general, a preassembled solar panel module in accordance with embodiments described herein may include a framed solar panel or a frameless solar panel. A framed or frameless, preassembled solar panel module is provided that includes a respectively framed or frameless solar panel configured for receiving and converting solar radiation to produce electrical power and multiple panel rails coupled in preassembly to a backside surface of the solar panel, including at least two panel rails disposed a quarter length or more along opposing longest edges of the solar panel. Multiple flexible snap connector components are each coupled in preassembly to one of the at least two rails and are each configured to for coupling with a complementary snap connector component of an adjacent preassembled solar panel module or of a wind deflector accessory, or both. One or more mounting feet are each coupled in preassembly at a selected location to one of the at least two panel rails and each mounting foot is configured for coupling at a selected location to a roof or to another sunlight receiving surface. A framed or frameless, preassembled solar panel module may include one, two or more overlapping surfaces that are each configured to receive and convert solar radiation to generate electrical power.

### Glass-Backsheet Solar Panels

In certain embodiments, the frame of a conventional solar panel is replaced on a glass-backsheet solar photovoltaic (PV) module by a set of long panel rails coupled to the bottom or backside of the module along the long edges of the module. A set of one or more short rails may be coupled along one or more short edges of the modules and/or spaced significantly from the short edges for example even at mid-rail locations between the long rails or for example a pair of short rails may be disposed ⅓ of the length of the long rails from the ends of the long rails. The rails may be configured to provide rigidity to glass-backsheet lamination in certain embodiments.

The rails may also be configured for providing a base for side snap brackets to couple to the solar PV module and/or for providing a base for corner snap brackets to couple to the module. The rails may also be configured for providing a base for mounting feet to couple to the solar PV module for securing the module to a roof or other sunlight receiving surface. The rails may also be configured to provide a structure for securing power electronics, cables and/or wires.

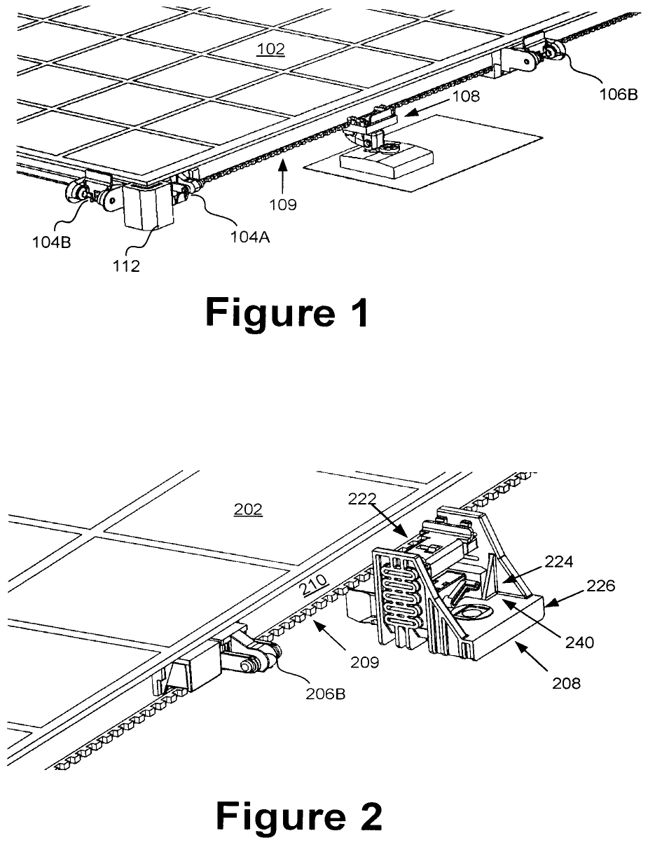

The coupling of a mounting foot to a panel rail can be performed in a number of ways including inserting pins from the foot into holes or slots in the rail (see, e.g., FIGS. 1-5). In addition to the method described to support the glass-backsheet PV module, another embodiment is provided that includes a panel rail system coupled to the bottom or backside of a solar PV module. In this embodiment, rails are coupled to the bottom or backside of the module at the long sides of the modules that are employed to provide utility for dual glass PV modules, which are modules constructed with a second sheet of transparent or translucent glass, while a solar PV module may also include a single top or frontside sheet of glass and an opaque polymer backsheet. In the dual-glass embodiment, the dual glass long rails are coupled to the glass backsheet, and may also be coupled to side snaps, long snaps, bumpers, mounting feet, power electronics or clips for holding cables or wires conducting electricity produced by the PV module, or combinations thereof.

In certain embodiments, polymer materials are employed for snaps, bumpers, brackets, mounting feet, or rail coatings, or combinations thereof, that allow the safe installation, use and operation of the pre-assembled solar panel modules without needing any equipment grounding or bonding alternative metal parts contained within the system.

Furthermore, the back coupling of the rails to the solar module serves in certain embodiments to prevent premature degradation of the solar module, which could otherwise reduce a module's power production over time, primarily but not exclusively due to the elimination of potential induced degradation, which is a condition that has afflicted many conventional framed, glass-backsheet modules.

### Panel Rails

An array of preassembled solar panel modules is provided in certain embodiments including one or more short panel rails coupled to the backside surface of the preassembled solar panel module disposed a quarter length or halfway or three-quarters or more along a length of opposing shortest sides of the solar panel between at least two long panel rails that are disposed at opposing longest sides of the solar panel.

An array of preassembled solar panel modules is provided in certain embodiments including bumpers at corners of the preassembled solar panel modules that extend normally from the backside surface further than any of the panel rails.

An array of preassembled solar panel modules is provided in certain embodiments, including at least two panel rails with outer facing walls having one or more features, e.g., notches, recesses, cutouts or protrusions, or combinations thereof, for coupling with complementary features of mounting feet or of snap connector components, or both, for preventing movement along the panel rails of the mounting feet or of the snap connector components, or both.

An array of preassembled solar panel modules is provided in certain embodiments, including one or more frameless solar panels. The one or more frameless solar panels may be strengthened by coupling two or more panel rails to a backside surface that are configured to stiffen the solar panel.

In certain embodiments, adjacent solar panel modules of an array are secured together by coupling together complementary snap connector components that may be coupled one to each of two adjacent preassembled solar panel modules.

### Preassembled Solar Panel Modules

FIGS. 1-10 illustrate several embodiments of fully or partially preassembled and/or installed solar panel modules. A fully preassembled solar panel module in accordance with certain embodiments includes two or more panel rails coupled to a backside surface, and two or more snap connector components and one or more mounting feet each coupled to at least one of the panel rails. Multiple solar panel modules of an array are secured to a roof or other sunlight receiving surface by coupling the one or more mounting feet to the roof or other sunlight receiving surface and by coupling together adjacent snap connector component pairs of adjacent solar panel modules. A partially preassembled solar panel module may be shipped before coupling the one or more mounting feet, which may be coupled at selected locations along the rails that are determined onsite based on locations of bands of sheathing strength and/or on specific details relating to the roof or other sunlight receiving surface upon which the solar array is being installed.

The mounting feet are designed in certain embodiments to be coupled to preassembled solar panel modules before anchoring the feet and the modules of the array to a roof or other sunlight receiving surface. A fully preassembled solar panel module includes the one or more mounting feet coupled thereto at least by the time of anchoring to the roof. During shipping, the mounting feet may or may not be coupled to a partially preassembled solar panel module.

A partially preassembled solar panel module may include two or more panel rails coupled to a backside surface. The solar panel module may be deemed to be fully preassembled when the one or more mounting feet are each coupled to one of the backside-attached panel rails. A fully or partially preassembled solar panel module may include one or more bumpers, one or more brackets, e.g., that may couple to ends of one or more panels rails or may include built-in snap connector components, and/or one or more snap connector components along one or more sides and/or at one or more of the corners for coupling together adjacent modules of a solar array. Particular configurations of side snap connectors and/or corner snap connectors may be customized specific to installation applications, e.g., residential pitched roof solar arrays may include snap-connected adjacent solar panel modules or solar farm arrays or multi-directional arrays that may include some adjacent solar panel modules that are snap-connected together and some that are not, and an array may include no snap connected adjacent solar modules in certain applications.

For residential pitch roof applications, snap connector components are included with preassembled solar panel modules in accordance with several example embodiments. For other applications, like low slope commercial or residential roof, preassembled solar panel modules may include fewer preassembled components. In such low slope applications, for example, either the side snaps, the corner snaps or the bumpers or combinations thereof may be excluded from a preassembled solar panel module in certain embodiments.

As another example, for an installation in which a customer prefers not to see brackets or snap-connector components along a perimeter edge of a solar array, the brackets or the side snaps or the corner snaps or the bumpers or combinations thereof may be optionally removed to provide a clean frameless aesthetic and an edge free from components which can catch debris or be used by insects for nesting. Wind deflectors may be provided that also serve aesthetically to block certain components from view and from damaging effects from wind or rain or other natural factors.

in some applications, like low slope commercial or residential roof, fewer than all installed components may be coupled in preassembly to the solar panel module. In a low slope application, for example, either the side snaps, the corner snaps or one or more bumpers or wind deflectors, or combinations thereof, may be excluded from a preassembled solar panel module or optionally included even module-to-module depending on the arrangement and particulars of the array and the installation surface. Any one or more of these components may be installed in a subsequent assembly step before transport to an install site or at an install site prior to mounting to a roof or other sunlight receiving surface, or even after mounting, or may be subsequently removed, or may left off one or more modules or from an entire array of preassembled solar panel modules.

A long panel rail, i.e., a panel rail that is aligned with a longest side of a solar panel, may be as long as the longest side of the solar panel, or may be much smaller, e.g., a quarter, a half or three-quarters of the length of the long side of the solar panel. When shorter panel rails are used, there may be more than one of them disposed coaxially or non-coaxially, and spaced-apart along the long side of the solar panel. For example, there may be two panels rails coupled along each long side of a preassembled solar panel module, one for coupling with a mounting foot and the other for coupling with a snap coupler component. In another example, three panel rails, each being one quarter of the length of the longest side of a solar panel module, are disposed coaxially along the longest side of a preassembled solar panel module and spaced apart by an eighth of the length of the longest side of the module.

The panels rails in a dual glass, frameless solar panel module configuration may provide some stiffening support to the module, although dual glass module already has two plane glass stiffness. In a glass-polymer backsheet module, that may or may not include a frame, the panel rails would be configured to provide enhanced stiffness in both the short and long sides of the module.

### Snap Couplers (or Snap-Connectors or Snaps)

In some embodiments, snap couplers or snap connectors or snaps may be provided at the corners, while snap couplers (or snap connectors or snaps) that are not at the corners may be coupled to long or short panel rails anywhere along the length of a rail. Snap connectors may be coupled in preassembly directly to a backside surface of a solar panel or to another component of a preassembled solar panel module other than a panel rail. In certain framed solar panel embodiments, snap connectors may be coupled to the frame of such a solar panel.

Snap connectors may couple to panel rails in the same way or in a different way as mounting feet couple to panel rails. Mounting feet and/or snap connectors may be shaped to include on one side a panel rail-receiving recess for receiving a panel rail at one of the remaining panel rail sides adjacent or opposite to the panel rail side that is attached to a backside of a preassembled solar panel module.

A slide-lock or rotation-lock mechanism may be provided on a mounting foot or snap connector, or instead on a panel rail or on the backside of the solar panel or on another attached or integrated component of a preassembled solar panel module, for securing a panel rail that has been received within the panel rail recess by moving a slide-lock or rotation-lock component from an unlocked position to a locked position and for decoupling the mounting foot and/or snap connector from the panel rail by moving the slide-lock or rotation-lock component back to the unlocked position.

The snap connectors may be otherwise configured as a sleeve disposed around a length of a panel rail, or the snap connectors may couple to the rails using a slider to catch a panel rail flange or using a bolt and nut mechanism or peg and slot mechanism in certain embodiments.

In certain embodiments, snap connectors may be coupled to rail connectors that connect long rails to short rails on one side (facing in away from the edge of the module) and that connect long rails to snap connectors on the other side (facing out towards the edge of the module). Snap connectors or snaps can serve multiple purposes, including creating a module to module coupling location, coupling to a long panel rail, coupling to a short panel rail, or efficiently transferring mechanical load from module to snap to foot, or combinations thereof. Snap connectors in certain embodiments offer a rotational lock of the snap coupling mechanism which improves the usability and the effectiveness of the snap locking operation by installers.

### Height to Gap Ratio (H/G)

An array of preassembled solar panel modules is provided that exhibits a height to gap ratio that is in a range between 0.42<H/G<15. H is a height of a preassembled solar panel module measured as a spacing of said backside surface of said preassembled solar panel module from said roof or other sunlight receiving surface, and G is a gap spacing between nearest edges of adjacent preassembled solar panel modules.

Another array of preassembled solar panel modules is provided wherein 0.42<H/G<3.

Another array of preassembled solar panel modules is provided wherein 0.42<H/G<1.5.

An array of preassembled solar panel modules is provided in certain embodiments wherein 20 mm<G<120 mm.

An array of preassembled solar panel modules is provided in certain embodiments wherein 50 mm<H<300 mm.

An array of preassembled solar panel modules is provided in certain embodiments wherein H<75 mm and G>37.5 mm.

An array of preassembled solar panel modules is provided in certain embodiments wherein H/G≈1.

The heights (H) and gaps (G) present in an array may be precisely set in preassembly. Precision gaps (G) are provided in certain embodiments by coupling panel rails a certain distance from panel edges and coupling snap connectors to the panel rails, so that adjacent modules can be snap coupled together with precise gaps (G). Precision heights (H) are provided in certain embodiments by coupling mounting feet to panel rails, wherein the mounting feet are configured for mounting preassembled solar panel modules at predetermined heights above the roof or other mounting surface. Foot heights may be adjustable after installation to adjust module heights.

### EXAMPLE EMBODIMENTS

In certain embodiments, mounting feet couple to brackets, and the brackets are coupled to the backside of the solar panel. In other embodiments, mounting feet don't couple to brackets but to panel rails, e.g., as illustrated in FIGS. 1-5, and 10. The panel rails are disposed close to the edges in certain embodiments so that mounting feet can be non-overlapping of the solar panel at a roof or other sunlight receiving surface location where snap toggle mounting is performed. Mounting feet can be easily adjusted to another location along a rail, e.g., that overlaps a sheathing strong point or band of sheathing strength, in preassembly or on location. Snaps, snap connectors or snap couplers can be easily adjusted to any location along a panel rail to align with complementary snaps, snap connectors or snap couplers on an adjacent preassembled solar panel module.

FIGS. 1-3 schematically illustrate partial top perspective views of example embodiments of a preassembled solar panel module including a mounting foot and snap connector components each coupled separately to one of multiple panel rails that are coupled to a backside surface of an otherwise frameless solar panel module. The backside coupled rails allow the secure mounting of frameless solar panel modules to rigid structures without the need of a frame. Replacing a traditional solar panel module frame with rails as shown lowers cost and improves reliability of the module by removing the risk of increased module degradation due to the voltage difference between the modules and the frame, called potential induced degradation or PID.

FIG. 1 schematically illustrates a preassembled solar panel module 102 in accordance with certain embodiments that includes complementary, e.g., male and female, corner snap couplers 104A, 104B, a side snap coupler 106B, which is configured to couple with a complementary side snap coupler of an adjacent preassembled solar panel module in an array, a corner bumper 112 and a mounting foot 108 that is shown engaging with a panel rail with notches 109 configured for interlocking with complementary features on the mounting foot 108.

FIG. 2 illustrates a preassembled solar panel module 202 including a side snap connector component 106A coupled to a panel rail 210 that has a series of notches 209 for coupling with a mounting foot 208 that includes a rail clip 222, a height adjustment mechanism 224, a pivot adjustment handle or lever 240, and a foot base 226 in accordance with certain embodiments.

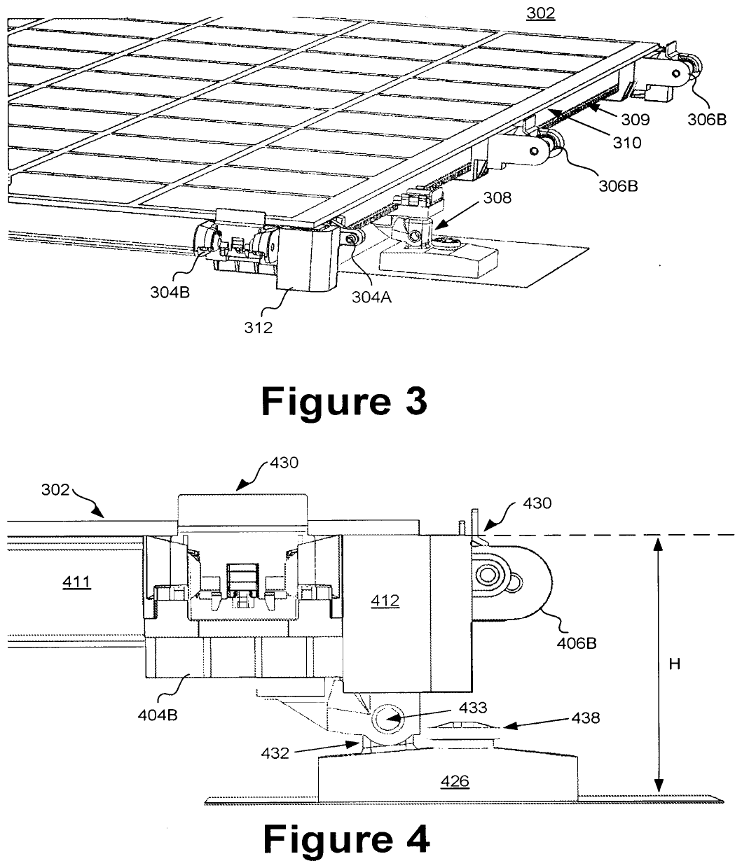

FIG. 3 illustrates a preassembled solar panel module 302 including corner snap couplers 304A, 304B, and a corner bumper 312, as well as side snap couplers 306B that are coupled to a panel rail 310 that has a series of notches 309 for interlocking with a complementary series of features of the snap coupler 306B and for coupling with and interlocking with complementary features of a mounting foot 308 in accordance with certain embodiments.

FIG. 4 schematically illustrates a side view of the solar panel module of FIGS. 1-3. In FIG. 4, we see the Female corner snap 404B with a rotating lock 430 and a corner bumper 412. This FIG. 4 shows the height H of the system or the dimension between the roof or other fixed surface and the back side of the preassembled solar panel module 402. This low profile design is valuable as it lowers the effective wind loading on the preassembled solar module array and by extension all its components which saves weight and cost.

FIG. 4 schematically illustrates a side view of one corner of the module 302 of FIG. 3 including a corner snap coupler 404B, a corner bumper 412, a short side panel rail 411. FIG. 4 also shows a foot arm 432 coupled to a foot base 426 via a pivot 433. A foot cap 438 provides a weather-resistant seal over the toggle anchor hole in the roof or other sunlight receiving surface to which the module 302 is mounted.

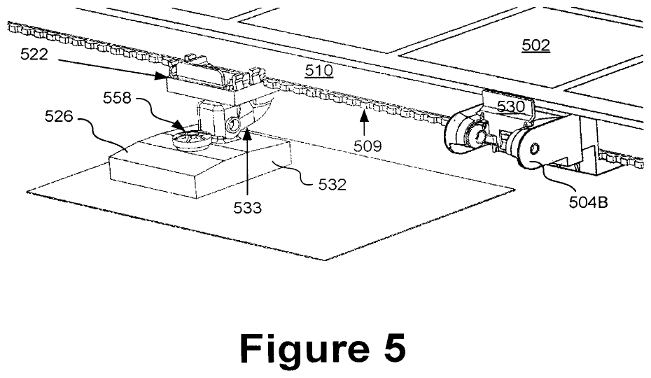

FIG. 5 schematically illustrates a partial top perspective view of a preassembled solar panel module 502 including a mounting foot 508 and a snap connector component 506B coupled separately to a notched rail 509, 510 that is attached along one edge of the backside of an otherwise frameless preassembled solar panel module 502 in accordance with certain embodiments. In FIG. 5, the mounting foot 508 that includes a foot base 526, a pivot 533, a foot cap 538 and a foot arm 532, as well as a foot rail clip 522 that is configured either to slide or rotate between open and closed positions for receiving and securing a panel rail 510.

Mounting feet and/or snap couplers can couple to rails at any of several locations along the rails.

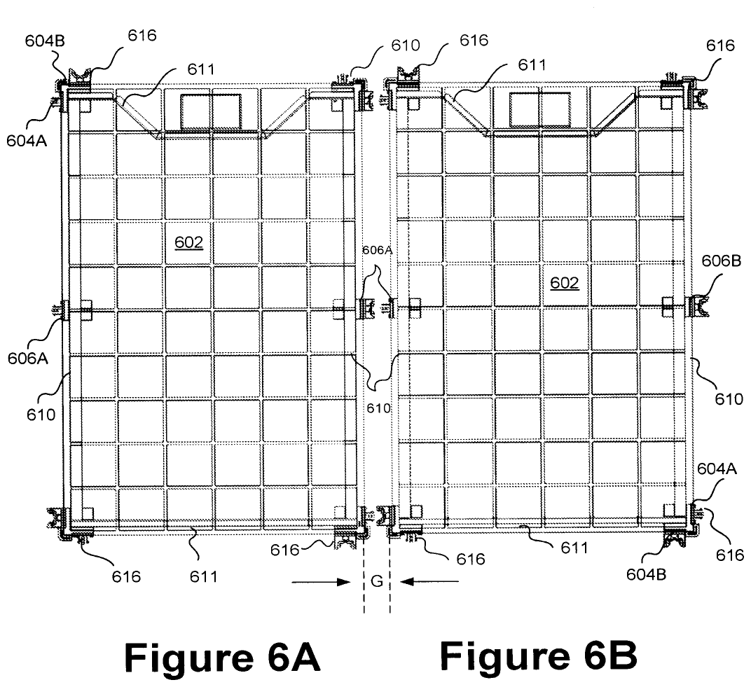

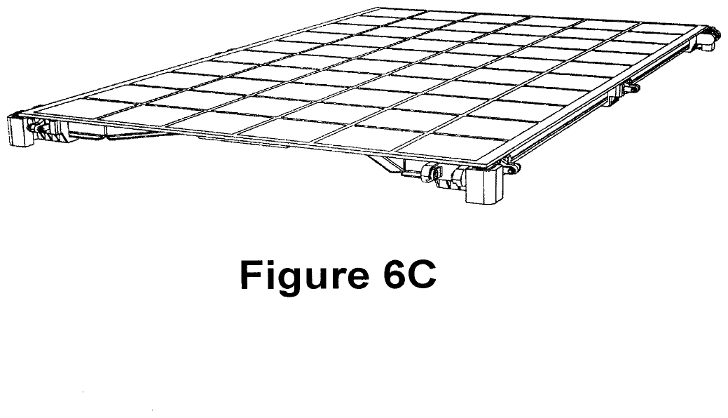

Referring now to FIGS. 6A-6C, brackets 616 that include snap connectors 604a, 1604B can couple long rails 610 to short rails 611 in certain embodiments. Adjacent modules such as those appearing in FIGS. 6A-6B can be coupled together by snap coupling, e.g., two complementary pairs of corner snap couplers 604A, 604B and a complementary pair of side snap couplers 606A, 606B, or other combinations of corner and/or side snap couplers. An edge to edge gap (G) is precisely defined by the sums of the extents of protrusion of the snap couplers from the edges of the modules minus the overlap of coupled complementary pairs, which in certain embodiments may be 1.5 inches or more. In certain embodiments, a height (H) of an installed, preassembled solar panel module or spacing between the backside surface of the module and a roof or other sunlight receiving surface is not greater than 6 inches, and may be less than 3 or 4 or 5 inches in certain embodiments.

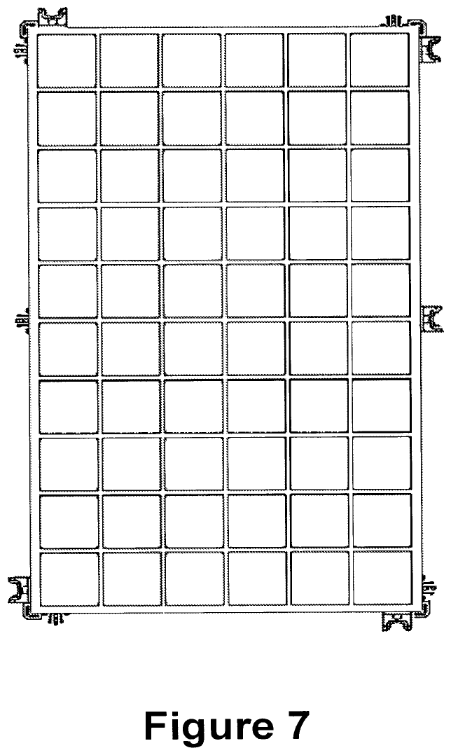

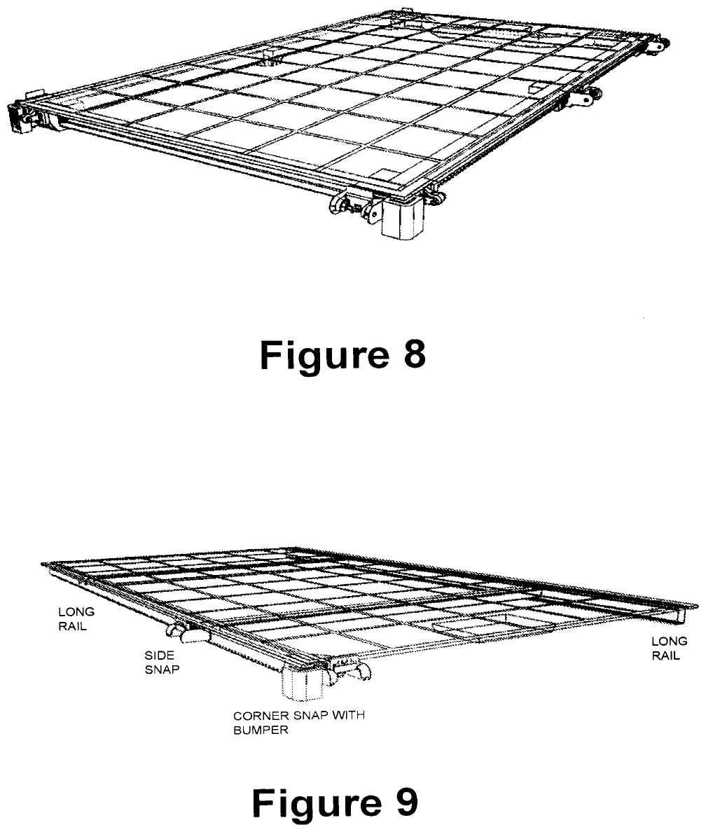

FIGS. 7-8 schematically illustrate examples of preassembled solar panel modules including snap connector components at various locations protruding away from solar panel edges for coupling with complementary snap connector components on adjacent modules in an installed array. Brackets can couple to ends of one or two rails and can include snap couplers. Brackets can also couple long and short rails together anywhere along rails. Brackets can be anywhere along rails, not necessarily in the corners only.

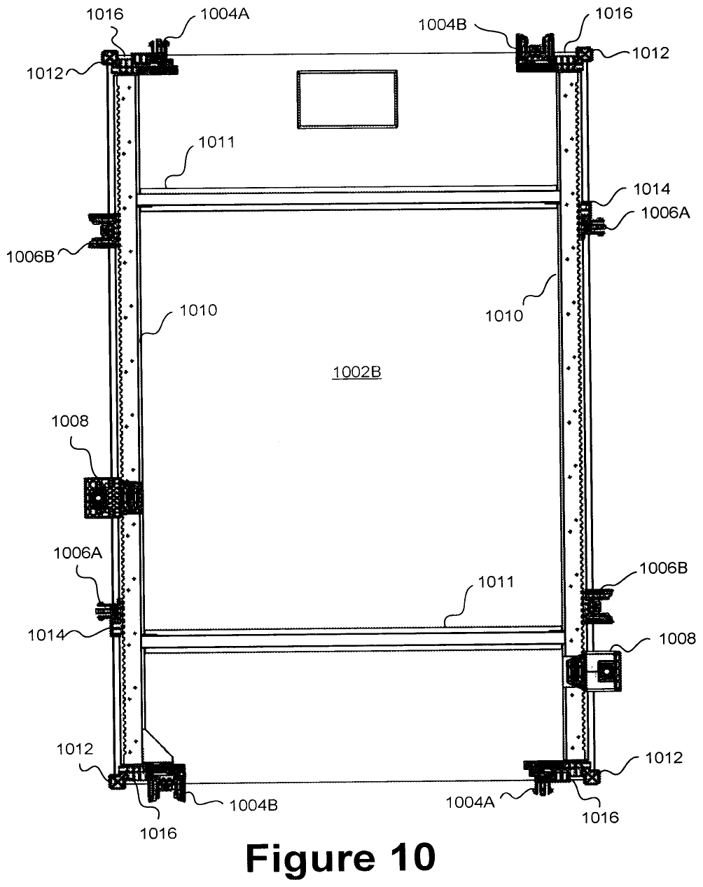

FIGS. 9 and 10 schematically illustrate an example embodiment of a preassembled solar panel module that includes two long rails disposed along the longest sides of a rectangular preassembled solar panel module and two short rails perpendicular to the long rails and coupling at both ends to inner walls of the long rails. FIG. 9 schematically illustrates a preassembled solar panel module 902 that includes one corner snap connector 904A and one side snap connector 906B that are configured for respectively coupling with a complementary corner snap connector (not shown, but see 1004B of FIG. 10) and a complementary side snap connector (not shown, but see 1006A of FIG. 10) each to one of two adjacent preassembled solar panel modules. The preassembled solar panel module 902 also includes two long rails 910 and two short rails 911 coupled together at mid-rail brackets 918, while the ends of each long rail 910 are coupled to corner brackets 916.

The example preassembled solar panel module 902 illustrated at FIG. 9 may include a polymer or glass backside surface. That is, in certain embodiments, the preassembled solar panel module 902 includes an opaque polymeric backside surface, while in other embodiments, the backside surface of the preassembled solar panel module 902 is formed of a transparent glass material. The front surface of the preassembled solar panel module 902 is formed of transparent glass or another transparent material such as a transparent polymer. In addition, the side snap connector 906B shown in FIG. 9 and the side snap connector 906A shown in FIG. 9 are complements of each other, i.e., for snap coupling together to couple adjacent modules within an array.

FIG. 10 schematically illustrate a preassembled solar panel glass-polymer module 1002B. The polymer back surface is opaque in the example of FIG. 10.

FIG. 10 schematically illustrates a preassembled solar panel module 1002 in accordance with certain embodiments that includes two sets of complementary snaps 1004A, 1004B at the corners of each of two short sides and two sets of complementary side snaps 1006A, 1006B disposed along each of two long sides not at the corners.

The preassembled solar panel module 1002 of FIG. 10 also includes two mounting feet 1008, each being coupled to one of two long rails 1010 that are coupled to the underside of the module 1002 near the longest sides and aligned parallel to the edges of the longest sides. Two short rails 1011 are also included in the example embodiment of FIG. 10, and are spaced considerably or significantly from the short side edges. Four corner bumpers 1012 and two side snap bumpers 1014 are also shown schematically in the example of FIG. 10 for protecting the module 1002 from collisions in the events leading to stable coupling within an installed solar array.

Corner brackets 1016 also couple with each end of the two long rails 1010. The corner snaps 1004A,1004B, the corner bumpers 1012 and the corner brackets 1016 may be separate components, may be coupled together or may be formed as an integral component that serves all three of these functions, or any two may be coupled or integral and separate from the third.

An interlocking photovoltaic (PV) mounting system is provided with adjustability to further reduce labor time and labor skill level in the installation of solar power systems. Adjacent preassembled solar panel modules are installed in precise alignment by snap connecting them together at selected locations along long and/or short edges and/or at the corners. Other methods are provided for precision alignment of preassembled solar panel modules in a solar array. In certain embodiments, the snap connectors are locked together by moving a rotational or slide locking mechanism from an unlocked to a locked position. The preassembled solar panel modules are configured to be adjustable in certain embodiment in the plane of and/or normal to the roof or other sunlight receiving surface upon which the module is installed.

### Rotational Snap Coupler Locking

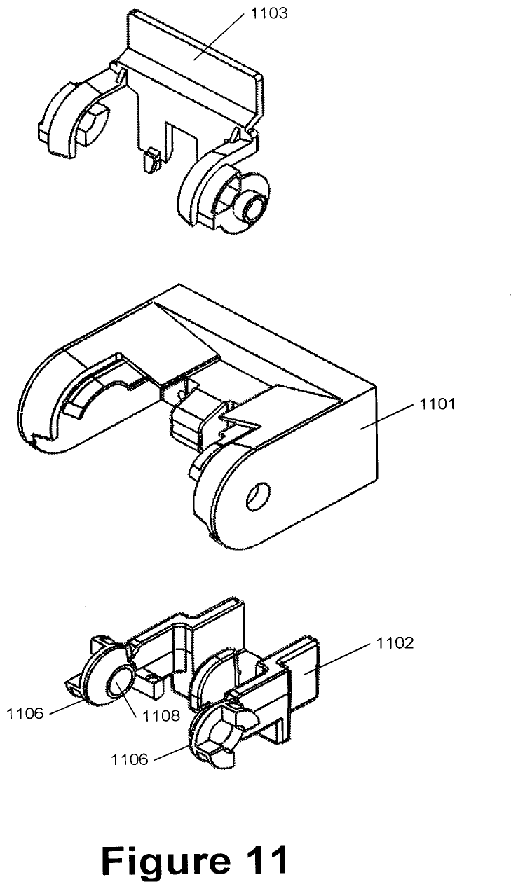

FIG. 11 schematically illustrates an exploded view of one of a pair of complementary snap connector components configured for coupling adjacent preassembled solar panel modules together in a solar array by snapping and locking them securely together. In certain embodiments, after installers align, engage and interlock the couplers on adjacent preassembled solar panel modules, the snap couplers are locked using a rotational operation. In the example embodiment of FIG. 11, three primary parts of this rotational locking mechanism include a snap housing 1101, a female snap coupler 1102 and a rotational snap lock 1103. The female snap coupler 1102 includes a pair of flexible members 1106 each defining inwardly facing recesses 1108.

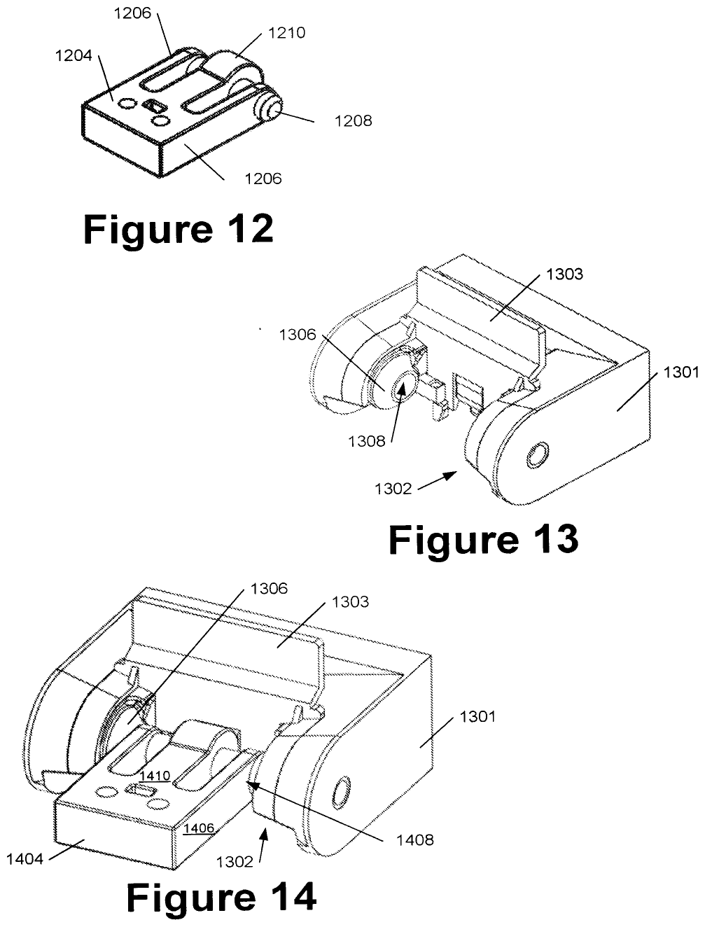

In FIG. 12, a male snap coupler 1204 is schematically illustrated which complements the female snap coupler 1102 of FIG. 11. The male snap coupler 1204 includes two flexible arms 1206 shaped with pins 1208 or protrusions 1208 that faced outward are complement the recesses 1108 of the female snap coupler 1102. The two flexible arms 1206 are disposed on either side of a central shoulder 1210. The complementary configurations of the female snap coupler 1102 and the male snap coupler 1202 provide for an efficient coupling mechanism for adjacent solar panel modules of a solar array. In addition, the rotational snap lock 1103 of FIG. 11 is movable to a locked position after the snapping together of the adjacent modules via the male and female snap couples 1102, 1202 to prevent the female snap coupler 1102 from moving away from the male snap coupler 1202, e.g., by preventing the flexing of flexible members 1206 and/or 1106 and/or by catching or interlocking with the male coupler 1202.

In FIG. 13, another embodiment including a female snap coupler housing 1301 is schematically shown with a rotational coupler lock 1303 in the open position. The female snap coupler 1302 includes flexible members 1306 defining recesses 1308.

FIG. 14 illustrates a female snap coupler 1302 within housing 1301 snap coupled with a complementary male snap coupler 1404 that includes flexible members 1406 that are configured with pins 1408 or protrusions 1408 that complement the recesses 1308. FIG. 14 shows the lock 1303 in an unlocked or open position such that the male and female snap couplers 1303, 1402 may be snap decoupled by applying a moderate force pulling them apart.

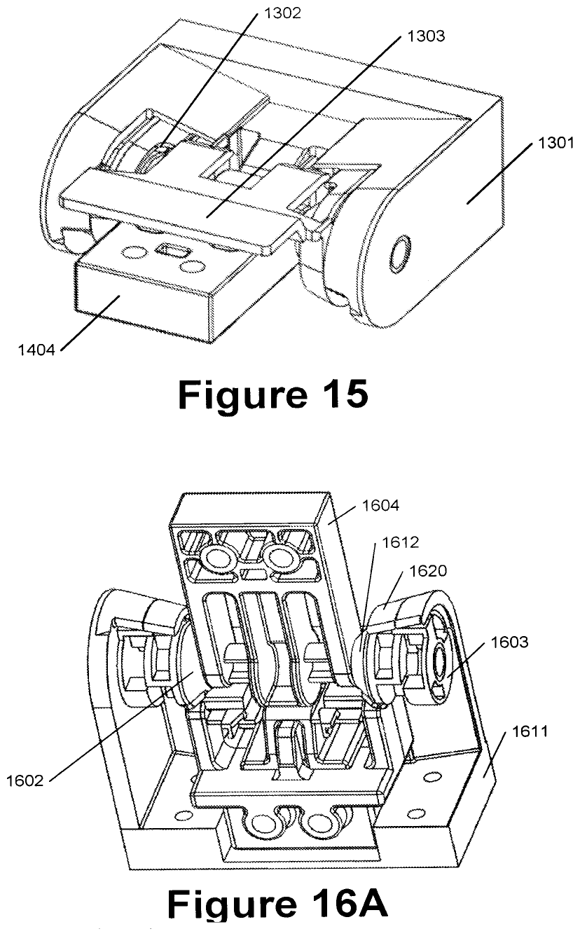

In FIG. 15, the male snap coupler 1404 that has been previously snap coupled together with the female snap coupler 1302 is locked into position by the rotational coupler lock 1303 being rotated down onto the male snap coupler 1404 into a closed or locked position. The rotation of the rotational coupler lock 1303 may be actuated by hand, or using a hand tool such as a screw driver, pliers or other similar common tool. The closed rotational coupler lock 1303 shown in FIG. 15 may also be configured to protect either or both of the male snap coupler 1404 and the female snap coupler 1302 from ultraviolet radiation when used outdoors.

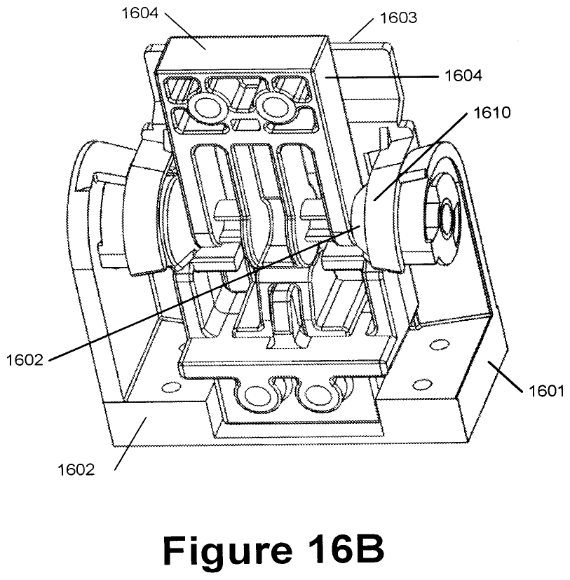

FIGS. 16A and 16B schematically illustrate bottom views of snapped together male and female snap couplers, wherein the lock 1303 is respectively in the open/unlocked position (FIG. 16A) and in the closed/locked position (FIG. 16B). FIGS. 16A-16B illustrate a female snap coupler assembly with a section through the right side to show the operation of the rotational coupler lock. As can be seen in FIG. 16A, when the rotational coupler lock 1603 is open, the female snap coupler 1602 is free to move and accept a male snap coupler 1604. However, when the rotational coupler lock 1603 is closed as in FIG. 16B, then the female snap coupler 1602 is not free to move and the male snap coupler 1604 is unable to snap decouple from the female snap coupler 1602. The shoulders 1610 of the rotational coupler lock 1603 and the flexible members 1612 of the female snap coupler 1602 have complementary shapes that fit together snugly, and/or at least overlap in side and front views and spaced apart by no more than a specified snap coupler flex tolerance, when the rotational coupler lock 1603 is in the locked position as in the example of FIG. 16B.

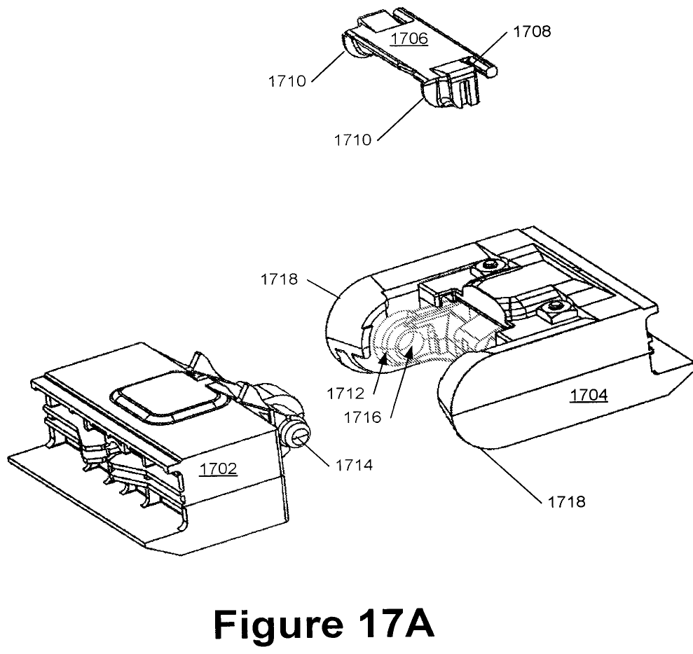

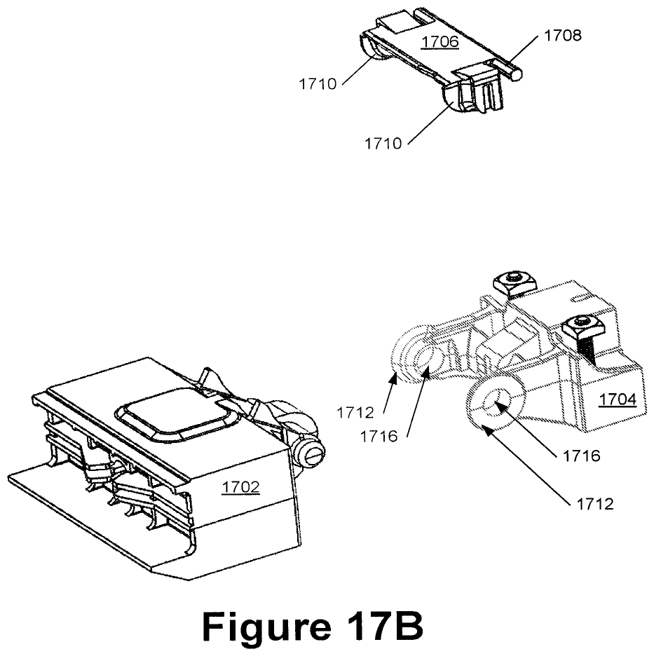

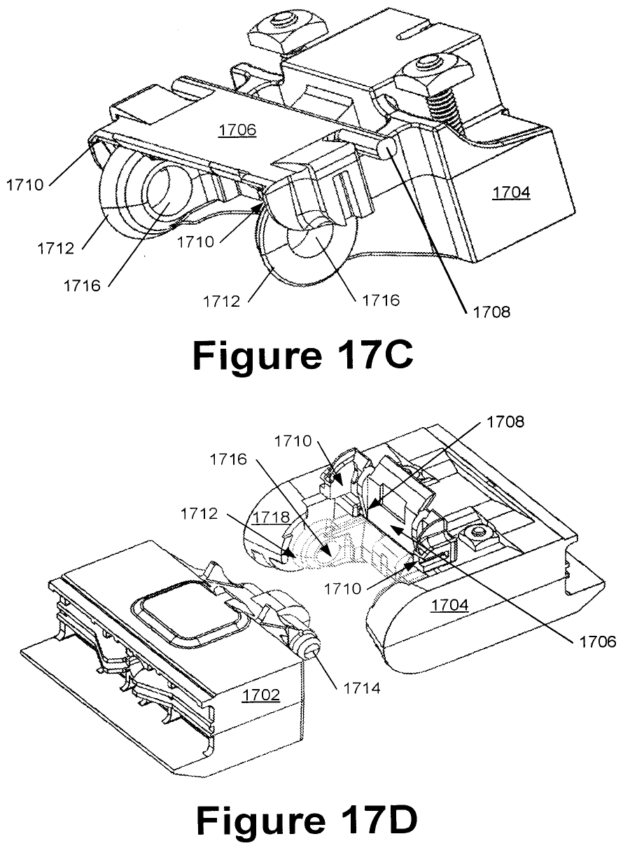

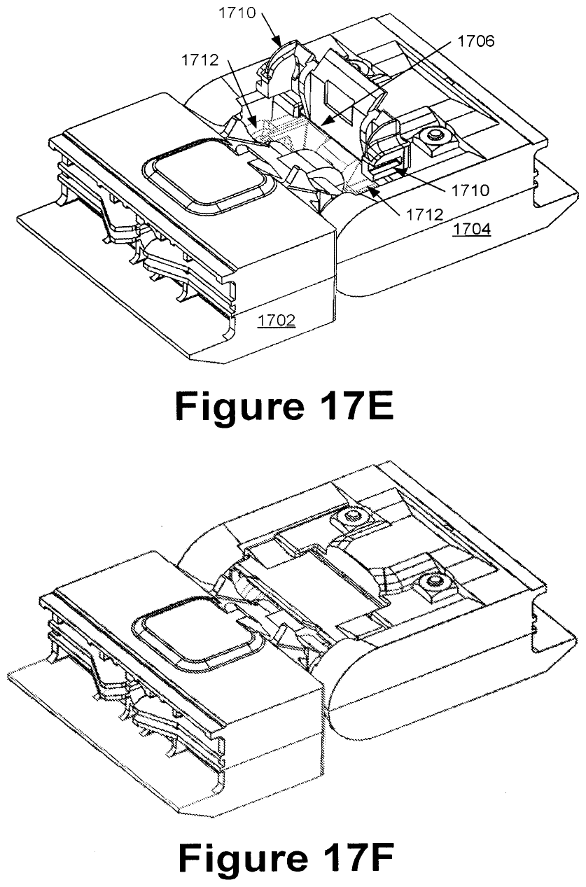

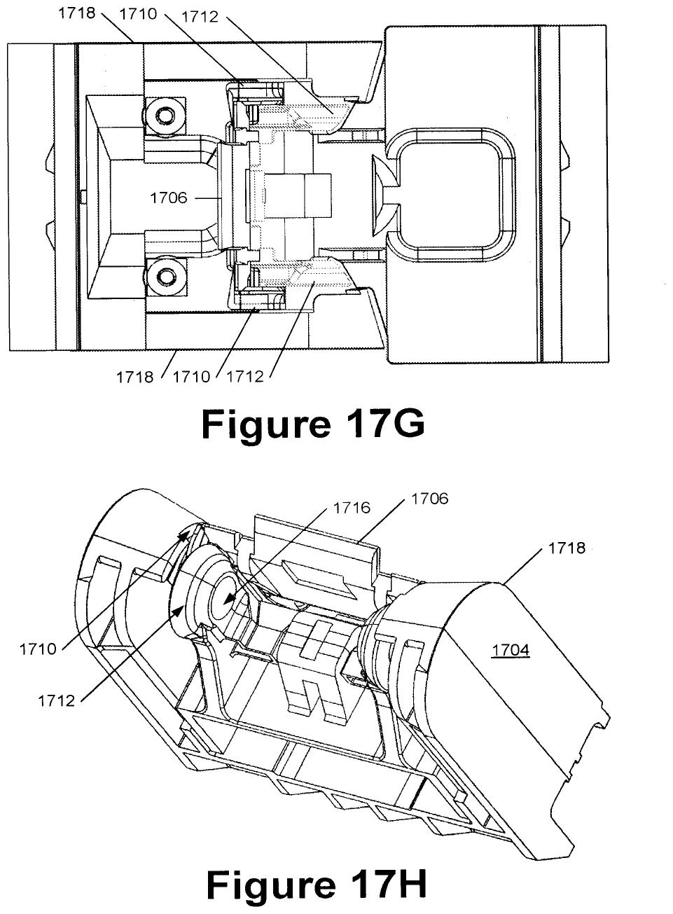

FIGS. 17A-17I illustrate in several views a rotational coupler lock in accordance with certain embodiments that is movable between unlocked and locked positions. In the unlocked position, male and female snap couplers may be snap coupled together or snap decoupled apart. In the locked position, the male and female snap couplers are prevented by the rotational coupler lock from either coupling or decoupling in certain embodiments. As such, the rotational coupler lock in accordance with these embodiments is omni-directional or bidirectional. In other embodiments, the male and female snap couplers may still be snap coupled together when the rotational coupler lock is in the locked position, because the motion of the male snap coupler towards the female snap coupler serves to push the rotational coupler lock to the unlocked position. Motion of the male snap coupler away from the female snap coupler is prevented however when the rotational coupler lock is in the locked position. As such, the rotational coupler lock in accordance with these embodiments is unidirectional.

FIG. 17A is an exploded view of spaced apart male and female snap couplers 1702 and 1704, respectively, and a rotational coupler lock 1706 exploded above the female snap coupler 1704. The rotational coupler lock 1706 is oriented in a locked position relative to the snap couplers 1702, 1704, while a clockwise rotation of 90° about the hinge 1708 would orient the rotational coupler lock 1706 in an unlocked position. Notably, the shoulders 1710 protrude down in the locked position and rotate upward when the rotational coupler lock 1706 is moved to the unlocked position. When the shoulders 1710 are up and out of the way of the flexible members 1712 of the female snap coupler 1704 in the unlocked position, these flexible members 1712 can flex outwardly to receive the male snap coupler 1702, which includes a pair of protrusions or pins 1714 that snap into recesses 1716 after the outward flexing of the flexible members 1712 permits the pins 1714 and recesses 1716 to become overlapped as the male snap coupler 1702 continues to move toward the female snap coupler 1704 even after the pins 1714 first contact the flexible members 1712 outside the rims of the recesses 1716. However, when the shoulders 1710 are protruding down as in FIG. 17A, the flexible members 1712 of the female snap couplers 1704 are prevented from flexing outwardly such that the snap coupler 1702, 1704 are locked into their snap coupled positions wherein the pins 1714 are disposed within the recesses 1716.

In alternative embodiments, the male snap coupler includes flexible members, while the female snap coupler is rigid, or both the male and female snap couplers may include flexible members. In the latter embodiment, additional locking strength may be provided to counter the enhanced tendency of the flexible members of both the male and female snap couplers to flex to the point of snap decoupling. The slide lock illustrated at FIG. 38, for example, includes four shoulders, instead of the two shoulders 1710 shown in FIG. 17A, for preventing the flexing of any of four flexible members, two each of the male and female snap couplers.

In FIG. 17A, the interior of the female snap coupler 1704 is encased and obscured within an outer housing 1718. FIG. 17B however schematically illustrates the female snap coupler 1704 of FIG. 17A with the outer housing 1718 removed in order to get a better view of the flexible members 1712.

FIG. 17C unexplodes the rotational coupler lock 1706 of FIGS. 17A-17B and illustrates how the rotational coupler lock 1706 prevent the flexible members 1712 from flexing outward to allow snap-coupling of male and female snaps 1702, 1704, respectively, and/or to allow snap-decoupling. The shoulders 1710 are spaced apart at a distance that is less than the distance apart that the flexible members 1712 need to flex outwardly to reach to permit snap coupling or snap decoupling. In certain embodiments, inward facing surfaces of the shoulders 1710 make sliding contact with outward facing surfaces of the flexible members 1712 when the rotational coupler lock 1706 is actuated from an unlocked position to a locked position or vice-versa.

FIG. 17D schematically illustrates spaced apart male and female snap couplers 1702, 1704, respectively, and a rotational coupler lock 1706 coupled by hinge 1708 to the outer housing 1718 of the female snap coupler 1704 and in an unlocked position with shoulders 1710 rotated up and out of the way of the flexible members 1712 that are free to flex outwardly and receive the male snap coupler 1702 sufficient for pins 1714 and recess 1716 to snap couple or snap decouple.

FIG. 17E shows the male and female snap couplers 1702, 1704, respectively, snap coupled together with pins 1714 occupying recesses 1716. The rotational coupler lock 1706 is still in unlocked position in FIG. 17E such that shoulder 1710 and flexible members 1712 are nonoverlapping in side view nor front view. The rotational coupler lock 1706 is schematically illustrated in FIG. 17F in the locked position preventing snap decoupling. The rotational coupler lock 1706 is in an unlocked position in the top view of FIG. 17G, and in a locked position in the perspective view of FIG. 17H, and in a locked position in the bottom view of FIG. 17I.

### Module Adjustment

Often PV module installers identify that a given roof has variability in its surface that can show up in the installed modules. Installers have a normal set of methods, tools and products they use to adjust standard PV modules to create a level solar PV array on the roof. SMASH has created a new method of module adjustment that can be performed immediately after a module is installed, after a row of modules is installed or after an entire array of modules has been installed. This method is enabled through a mechanism that allows quick adjustability and easy removal of the PV module for maintenance. In the first embodiment, we find an assembly of parts making up a module-adjusting mounting foot with built-in adjustability for raising or lowering a flat plate solar collector or PV solar power module to account for unevenness in the roofing or mounting surface.

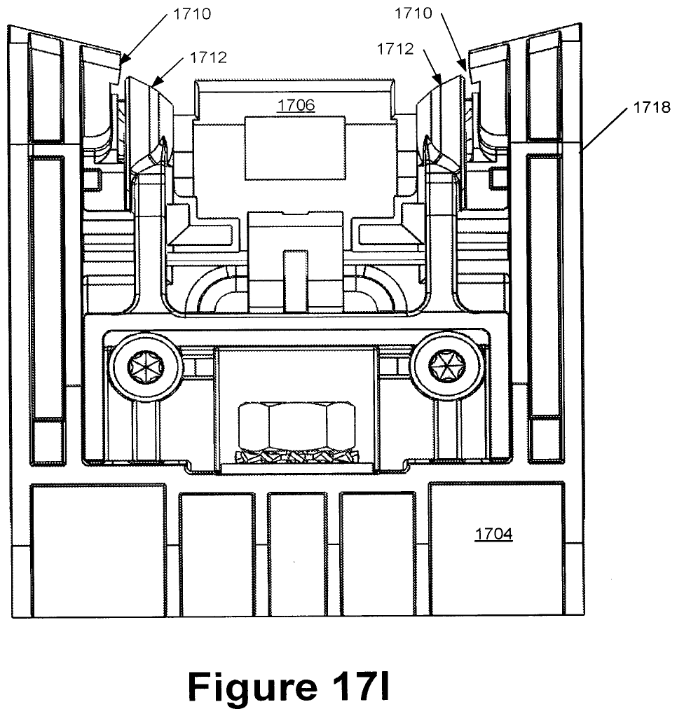

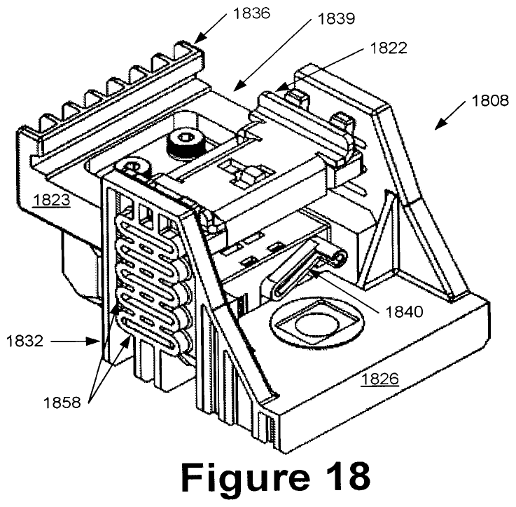

FIG. 18 schematically illustrates another embodiment of the mounting foot 1808 that is configured for coupling with a panel rail that is attached to a backside surface of a preassembled solar panel module and that has specific features that can be engaged by a module foot clip insertion method. These embodiments show unique adjustment features for the foot 1808. In FIG. 18, examples of a rail clip 1822 and a foot adjuster handle 1840 are shown for manually adjusting relative orientations of the rail clip base 1823 and foot arm 1832. The foot 1808 may be adjusted between two or more foot adjustment levels 1858 by actuating the foot adjuster handle 1840. Additional examples of mounting feet 1808 in accordance with the embodiment illustrated at FIG. 18 are described in US patent application serial number PCT/US16/44151, which is incorporated by reference.

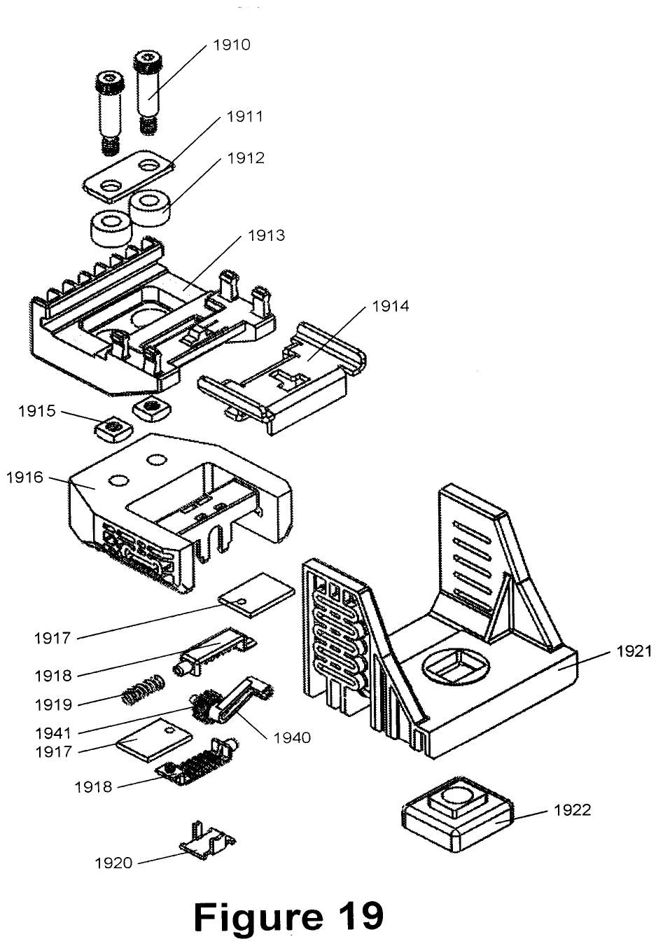

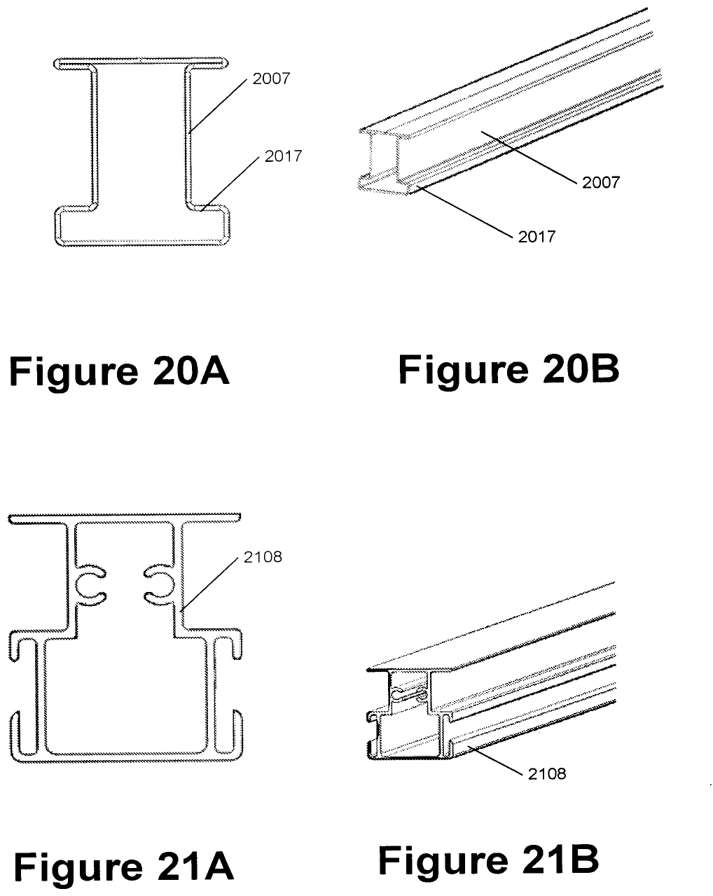

FIG. 19 schematically illustrates an exploded view of an adjustable mounting foot in accordance with certain embodiments. The two shoulder screws 1910 attach the stiffener base 1913 and arm 1916 through a bushing retainer 1911 and bushing 1912. The arm 1916 is locked into position using square nuts 1915. A stiffener clip 1914 slides into the stiffener base 1913 to lock to a stiffener (not shown, but see FIGS. 20A, 20B, 21A and 21B, and US serial number PCT/US16/44151, which is incorporated by reference). The stiffener 2007 of FIGS. 20A-20B and the stiffener 2108 of FIGS. 21A-21B are attached in preassembly to a backside surface of a solar panel and serve as a mechanical element that provides rigidity in certain embodiments to a frameless preassembled solar panel module and may be configured to couple various components such as mounting feet and snap couplers to a preassembled solar panel module.

In the example of FIG. 19, a rack and pinion mechanism is employed between the arm 1916 and arm base 1921 to provide adjustability between a preassembled solar panel module and the arm base 1921. A rack and pinion mechanism in accordance with this example embodiment includes two slide locks 1917, two lock racks 1918, a lock spring 1919 and a rack support plate 1920. These pieces sit on an arm base 1921 which sits on a flashing base 1922. A foot adjuster handle 1940 permits actuation of the circular gear 1941 along the grooves of the lock racks 1918

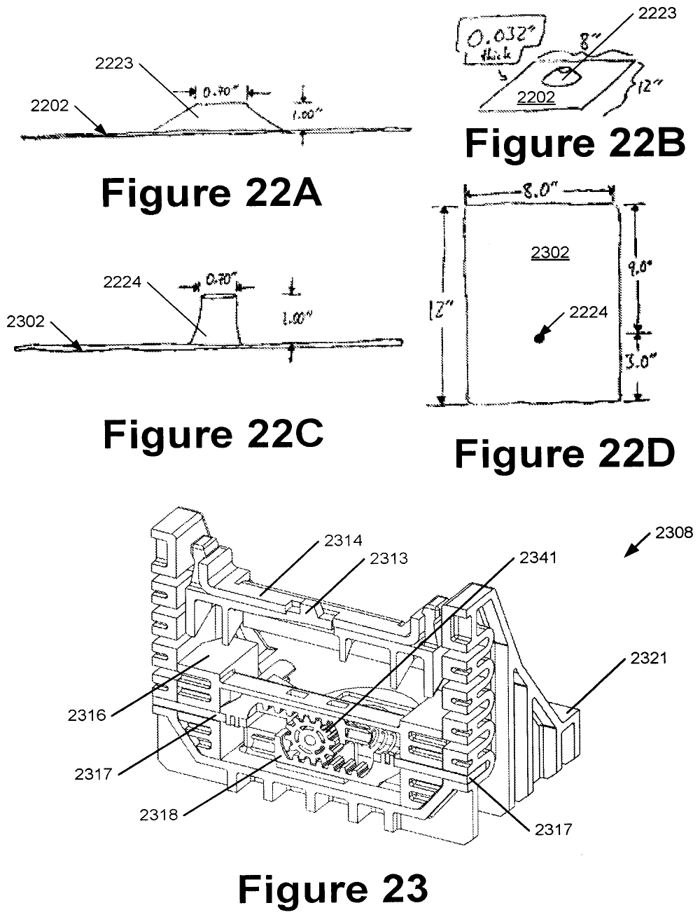

FIGS. 22A-22D schematically illustrates a couple of example embodiments of metallic flashing 2202, 2302 which may be coupled with a flashing base 1922 (not shown, but see FIG. 19) of a mounting foot in accordance with certain embodiments. A conical metallic flashing 2223 may be joined and aligned with a same sloped surface found in the bottom of the flashing base 1922 of FIG. 19. In the example of FIGS. 22A-22B, the narrow end of the conic is 0.70 inches in diameter and the conic 2223 has a height of one inch. The wide end of the conic which meets the flashing 2202 may be 1-3 inches in diameter. The flashing 2202 may be 0.032 inches thick in one example and 8 inches by 12 inches in size.

A tubular metallic flashing 2224 may also be joined and aligned with a tubular surface found in the bottom of the flashing base 1922 of FIG. 19. In the example of FIGS. 22C-22D, the tube has a diameter of approximately 0.70 inches and a height of about one inch. The base of the tube 2224 may be between 0.70 and 1.0 inches in this example, and the tube 2224 may be disposed nine inches from one end of the flashing 2302 in the long dimension and three inches from the other end, and approximately in the middle in the short dimension four inches from either end.

FIG. 23 schematically illustrates a perspective view of a section of a height adjustable mounting foot 2308 that illustrates the integration of rack and pinion parts 2317, 2318, 2341 with the arm 2316 and the arm base 2321. The arm 2316 is configured for coupling with a stiffener base 2313, while a stiffener clip 1914 is configured to slide into the stiffener base 1913 to lock to a stiffener (not shown, but see FIGS. 20A, 20B, 21A and 21B, and US serial number PCT/US16/44151, which is incorporated by reference). The stiffener is coupled to a backside surface of a preassembled solar panel module, such that a height of a preassembled solar panel module above a roof or other sunlight receiving surface to which the module is installed may be adjusted by adjusting the height of the mounting foot in accordance with these embodiments.

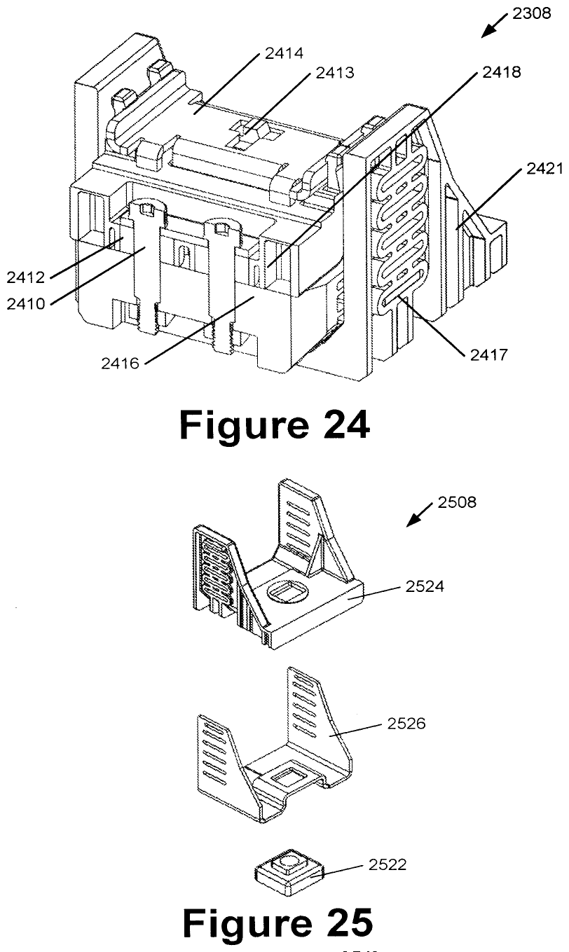

FIG. 24 schematically illustrates a perspective view of another section of the height adjustable mounting foot 2308 of FIG. 23. The adjustable mounting foot 2308 includes two shoulder screws 2410 (alternatively, a single shoulder screw or three or more shoulder screws may be used) coupling multiple parts together, including bushing 2412, stiffener base 2413, stiffener clip 2414, arm 2416, slide locks 2417 and lock racks 2418 and arm base 2421.

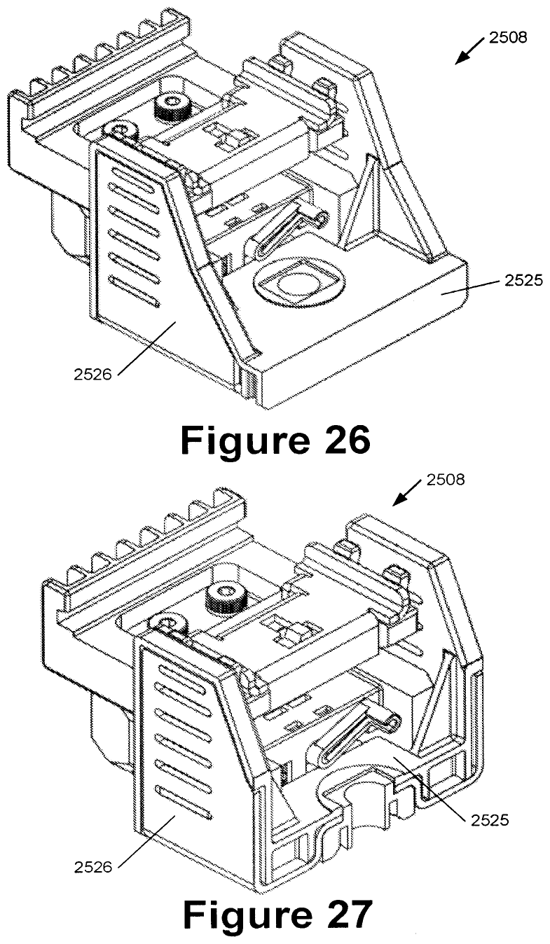

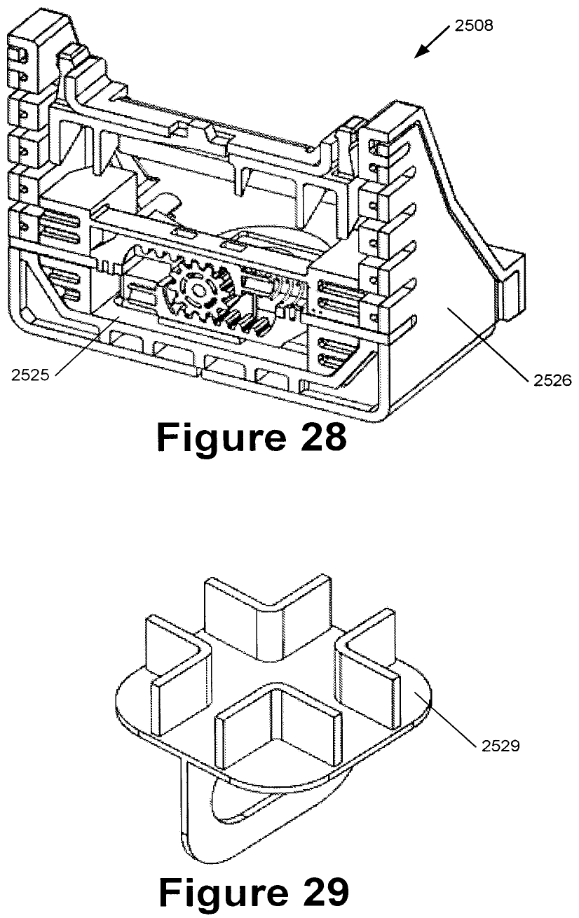

FIG. 25 schematically illustrates in exploded view another embodiment of a height adjusting mounting foot 2508 that provides greater strength and greater adjustability resolution due to employing an arm base support 2526 under a modified arm base 2525. In this example, the arm base support 2526 couples with flashing base 2522. FIGS. 26, 27 and 28 schematically show example details of the arm base 2525 and arm base support 2526 integrated within a height adjustable mounting foot 2508.

### Alignment of Modules

In the installation of flat plate solar collectors or solar PM modules, workers align the modules with

an area on a fixed structure (e.g. a roof or roof eave or roof ridge or any other sunlight receiving surface). This alignment can be done by placing a chalk line on the roof and following the line or by placing a string line on the first and last modules on a given row of modules to check their alignment or by measuring the modules' edges to the eave. In addition, in the implementation of a system to reduce labor time and skills in the installation of solar power, one may consider how to align modules as they are installed to prevent misalignment and rework.

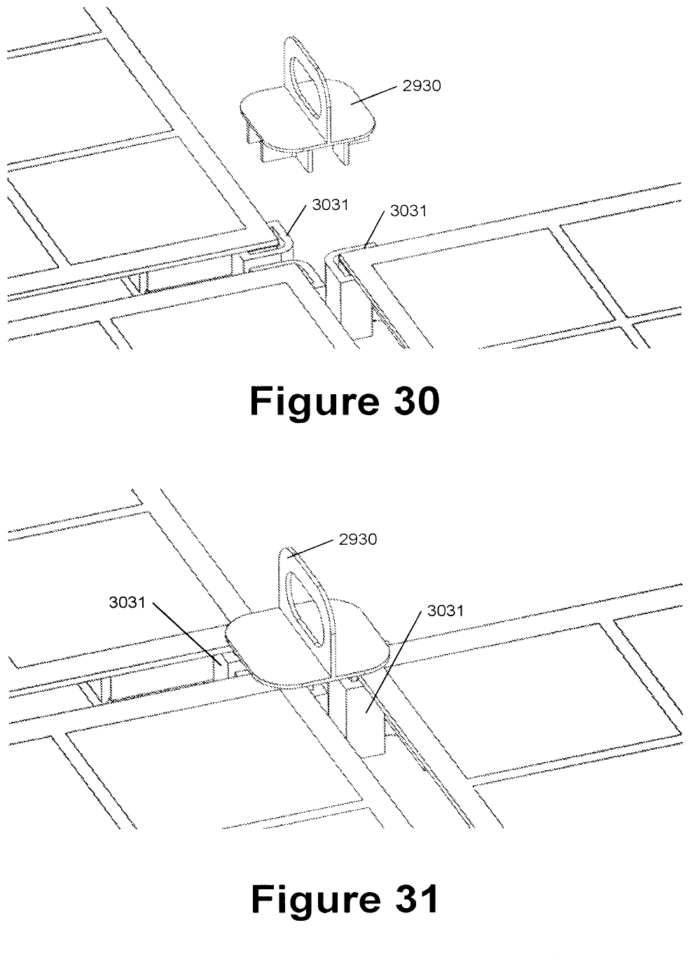

FIGS. 1-16 schematically illustrate snap couplers that serve to couple adjacent preassembled solar panel modules together with precision alignment. The following example embodiments describe further methods and apparatuses that may be used to help workers align modules with a fixed surface. In certain embodiments, an alignment tool 2930 as in the example of FIG. 29 may be used to physically align adjacent preassembled solar panel modules at their corners. For framed or frameless modules, corner bumpers 3031 as in the example of FIG. 30 may be coupled to the backside surface of the modules to prevent damage to edges of the modules.

For a first row of two or more preassembled solar panel modules of an array, workers may use the following example alignment steps. First, provide the location of the outer corner feet of the anchor module that is closest to the eave of the roof. This is the reference foot that controls the location of the subsequent foot installation. Second, measure the distance from the eave of the roof to the two corner bumpers on the anchor module that are closest to the eave. The two measurements should be within 1/16th of an inch as an example tolerance that may be specified. This ensures the module's front ends will be parallel to the eave. Third, snap on the next module and position the feet with the flashing. The feet may be moved after this step, but foot adjustment may be better performed before this step. Do not attach the foot to the roof at this time. Fourth, engage alignment tools 2930 at each inner corner of the module 3031 that are adjacent to the corners of the previous module. After engaging the alignment tool, measure the outer corner bumper of the new module to within 1/16″ (example tolerance) of the original measurement obtained from the anchor module or first preassembled solar panel module at a corner of the array. Adjust the new module location as necessary. This would ensure the new module is aligned with the anchor module, and therefore, aligned with the eave of the roof. Fifth, with the alignment tools 2930 engaged, attach the feet to the sheathing using toggle bolts (see U.S. Ser. No. 15/138,437, which is by the same Applicant as the present application and is incorporated by reference). Sixth, remove the alignment tools. Seventh, repeat the third to sixth steps for subsequent module installation. These seven steps should keep the first row parallel to the eave of the roof. FIGS. 29, 30 and 31 schematically illustrate example tools 2930 and corner bumpers 3031 that may be used in accordance with the described first through seventh example steps.

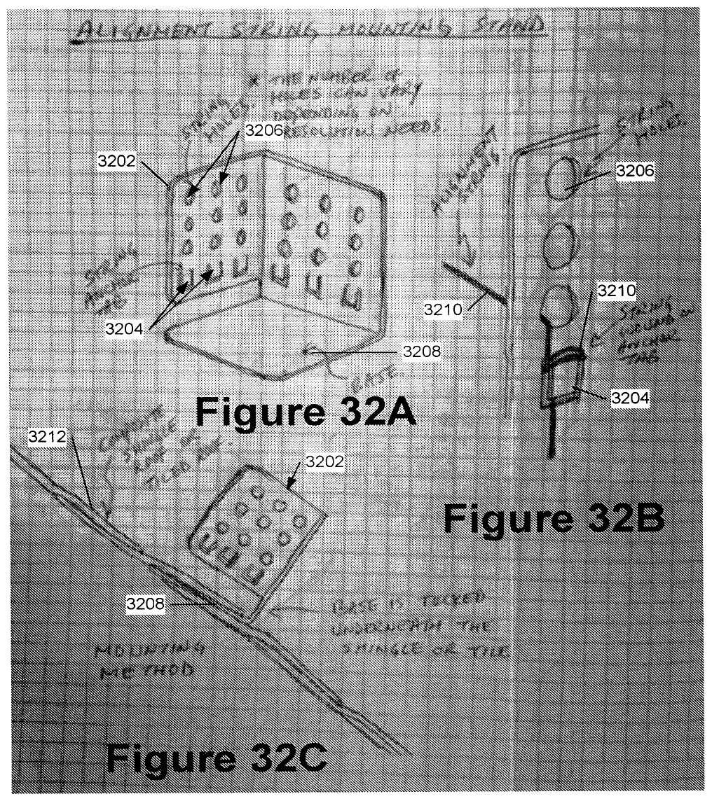

In another example, an alignment control tool 3202 as in the example of FIGS. 32A-32C may be used to provide a reference control for aligning adjacent modules to within specified tolerances. FIGS. 32A, 32B and 32C schematically illustrate an alignment string mounting stand 3202 that includes one or more string mounting tabs 3204 and one or more string holes 3206 defined within one or more plates that are perpendicularly disposed relative to a base plate 3208 of the tool 3202. FIG. 32B illustrates how an alignment string 3210 may be wound around an string mounting tab 3204 and feed through one of the string holes 3206. The number of string holes may vary depending on the resolution desired. FIG. 32C illustrates the alignment string mounting stand 3202 with its base plate 3208 tucked underneath a shingle or tile of a shingle or tile roof.

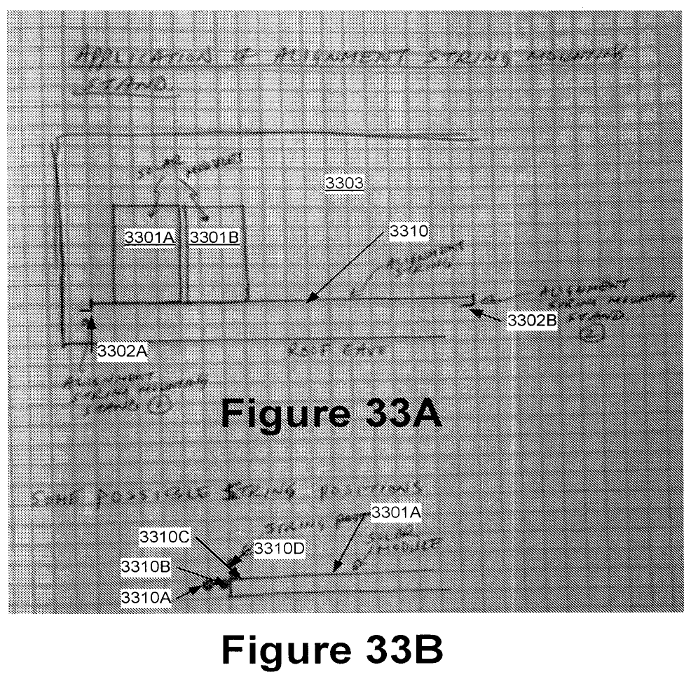

FIGS. 33A-33B illustrate applications of the alignment string mounting stand 3202 of FIGS. 32A-32C. Two preassembled solar panel modules 3301A and 3301B are shown on a sunlight receiving surface 3303. Two measuring string mounting stands 3302A and 3302B are disposed at opposite ends of an area of the sunlight receiving surface 3303 within which the solar array is being installed. An alignment string 3310 is tautly coupled between the tools 3302A and 3302B. FIG. 33B illustrates different string positions 3310A, 3310B, 3310C and 310D relative to a preassembled solar panel anchor module 3301A, e.g., at the corner 3310B, 3310C or slightly displaced above the corner 3310D or slightly displaced from the corner in the plane of the module 3310A. The snap couplers (not shown, but see FIGS. 1-16) may be repositioned along the panel rails of one or more of the preassembled solar panel modules when it appears such an adjustment may be used to enhance the alignment of one or more of the modules within the array, e.g., when the edge of one or more modules does not align with the string.

See FIGS. 32 and 33 for details about this alignment method and apparatus.

### Slide-Lock Couplers

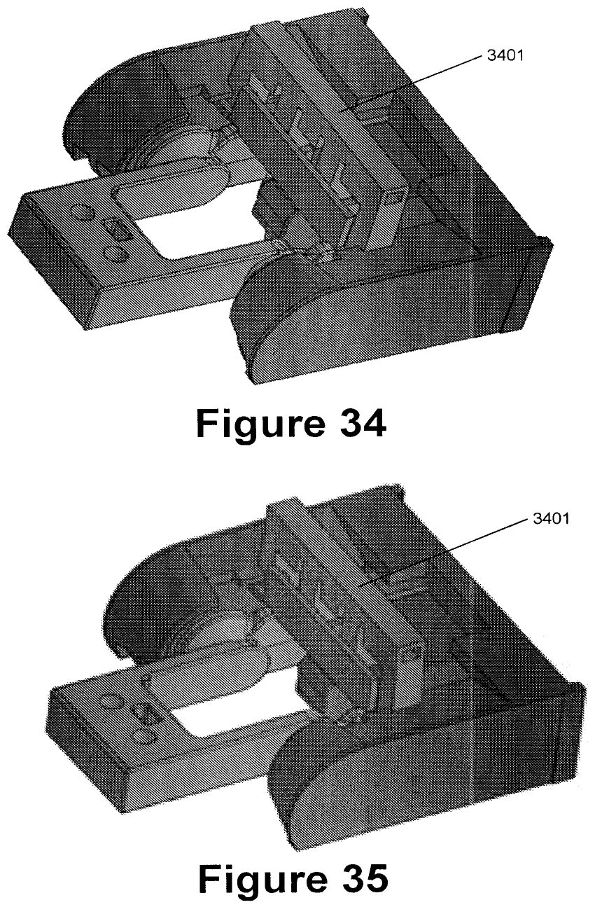

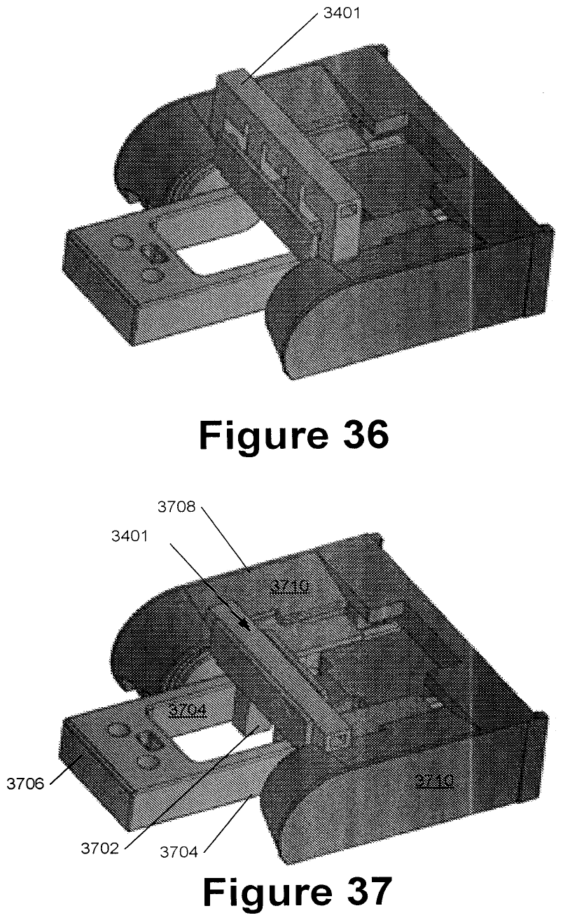

As an alternative embodiment to the rotational coupler locking described with reference to FIGS. 11-15, a slide lock including a slide lock handle 3401 is schematically illustrated in FIGS. 34-38 which performs much of the same utility in a different construction. FIGS. 34, 35 and 38 illustrate the slide lock in the open or unlocked position, while FIGS. 36 and 37 illustrate the slide lock in the closed or locked position. Referring to FIG. 37, a pair rigid slide lock protrusions 3702 from slide lock handle 3401 have been slid into a position to prevent flexing by the flexible members 3704 of the male snap coupler 3706, thereby locking the male snap coupler 3706 into interlocking engagement with the female snap coupler 3708.

In this example, the female snap coupler 3708 may have rigid members 3710 that include recesses that match protrusions from the flexible members 3704 of the male snap coupler 3706. The mating of the recesses and protrusions provides snap coupling capability, while the slide lock provides locking engagement and prevents snap decoupling when in the locked or closed position as in FIG. 37.

FIG. 38 illustrates a single rigid slide lock protrusion 3802 in the open position that does not prevent the flexible members 3805 from flexing towards each other for snap decoupling, while the protrusion 3802 is shaped and sized to just slide between inner arm guard protrusions 3804 that extend from the insides of each of the flexible members 3805 in the example of FIG. 38.

### Module Adjustment

In certain advantageous embodiments, solar installers can quickly adjust attachment points to the roof. In certain embodiments, one or two bolts may be loosened and/or tightened by hand or with a simple tool such as an electric drill, an allen wrench or a screwdriver to adjust a position of a mounting foot and/or a snap coupler to a different position along a panel rail or bracket that has been attached to a backside surface of a preassembled solar panel module. In this way, any modules within an array that are not aligned or that have preassembled mounting feet disposed at a roof or other surface location that is not readily available for mounting with a toggle bolt or that have adjacent snap couplers that are not precisely matched in their location protruding from an edge of a preassembled solar panel module can be efficiently and safely adjusted.

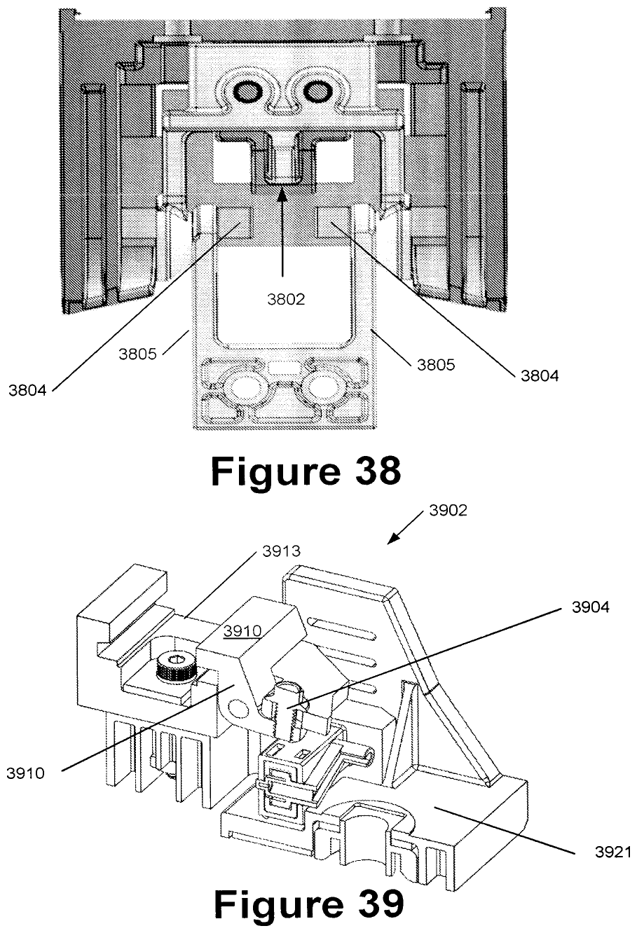

FIG. 39 schematically illustrates a section of a perspective view of a mounting foot that is configured to couple to a panel rail that is attached to a backside surface of a preassembled solar panel module in accordance with certain embodiments. The mounting foot 3902 shown schematically in FIG. 39 includes a jaw clamp 3910 that is tightened to an arm base 3921 by a single bolt 3904 (or two or three or four bolts 3904 in other embodiments). The jaw clamp 3910 can be tightly coupled to stiffener base 3913 when the bolt 3904 is tightened and easily loosened for making adjustments in location of coupling along a panel rail that may be fixed to a backside surface of a solar panel. In the example embodiment of FIG. 39, the mounting foot 3902 is configured to clamp to a stiffener (not shown, but see FIGS. 20A-21B for example) that may include a flange 2017 that the jaw clamp 3910 can be tightly coupled to by tightening one or two or more jaw clamp set screws 3904.

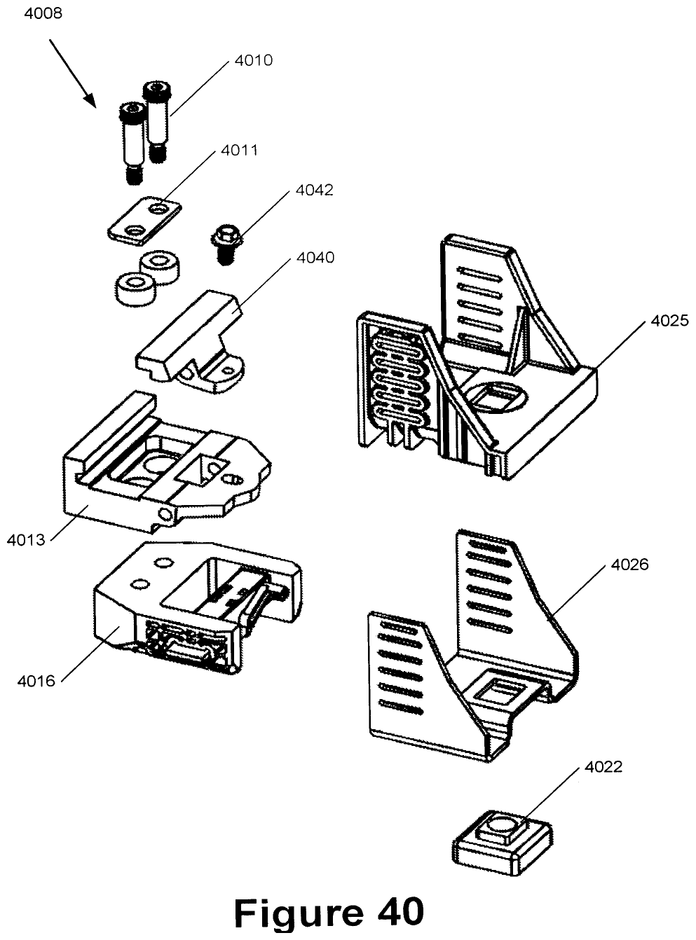

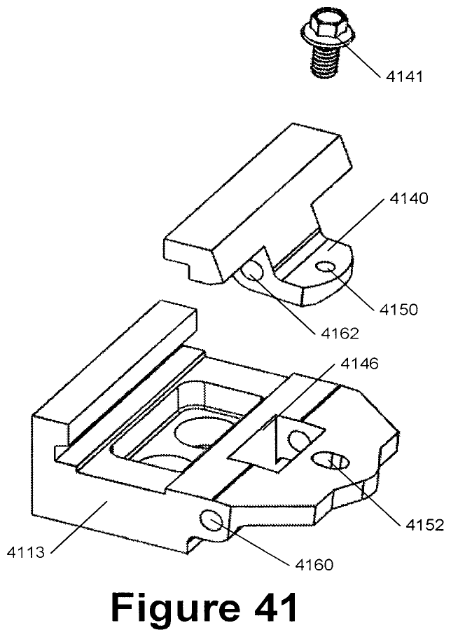

FIG. 40 schematically illustrates an exploded view of jaw clamping mounting foot 4002. The two shoulder screws 4010 attach the stiffener base 4013 and arm 4016 through a bushing retainer 4011 and bushing 4012. The jaw clamp 4042 tightens to a flange of a stiffener using one or two or more bolts 4042. FIG. 40 also schematically illustrates in exploded view another embodiment of a height adjusting mounting foot 4008 that provides greater strength and greater adjustability resolution due to employing an arm base support 4026 under a modified arm base 4025. In this example, the arm base support 4026 couples with flashing base 4022. The arm base 4025 and arm support 4026 may be integrated within a height adjustable jaw clamp mounting foot 4008. The jaw clamp 4040 and the jaw clamp set screws 4042 may be used in embodiments that involve a streamlined installation process by giving the installer a clamping process to secure the foot 4008 to the stiffener or panel rail that is fixed to a backside surface of a preassembled solar panel module in accordance with certain embodiments. The jaw clamp set screws 4042 may be locked directly into the jaw clamp 4040, such that no clip action is required in certain embodiment, just the turning of a bolt 4042.′

FIG. 41 is an exploded view of a jaw clamping assembly in accordance with certain embodiments. In the example of FIG. 41, a jaw clamp 4140 and jaw clamp set screw 4141 may be coupled to a stiffener base 4113 clamping a stiffener, e.g., at a flange and coupling a mounting foot to a preassembled solar panel module that has the stiffener attached thereto. The lower portion of the jaw claim 4140 is inserted through the cavity 4146 in the stiffener base 4113. The screws 4141 are inserted first through holes 4152 in the stiffener base and then through hole 4150 defined in the jaw clamp 4140. The hole 4150 may be threaded or a nut and washer may be used. The jaw clamp 4140 and the stiffener base 4113 may have cylindrical cavities 4160 and 4162, respectively, than may be aligned coaxially for joining the jaw clamp 4140 and stiffener base 4113 by inserting a pin through both cavities 4160 and 4162.

Several solar panel modules may be coupled together into an array using any of the preassembled solar panel modules described herein even if certain modules have not been described as being configured for coupling together with other modules into an array. Electrical current generated by solar radiation impinging upon the solar panels of the solar panel modules array and being converted to electrical energy may be passed from module to module until a power storage component is reached or until a circuit for powering lights, appliances or other electronically powered equipment is reached or until an outside power line is reached for transmitting the electrical power to the grid.

Various modifications and alterations of the invention will become apparent to those skilled in the art without departing from the spirit and scope of the invention, which is defined by the accompanying claims. It should be noted that steps recited in any method claims below do not necessarily need to be performed in the order that they are recited. Those of ordinary skill in the art will recognize variations in performing the steps from the order in which they are recited. In addition, the lack of mention or discussion of a feature, step, or component provides the basis for claims where the absent feature or component is excluded by way of a proviso or similar claim language.

While various embodiments of the present invention have been described above, it should be understood that they have been presented by way of example only, and not of limitation. The various diagrams may depict an example architectural or other configuration for the invention, which is done to aid in understanding the features and functionality that may be included in the invention. The invention is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the present invention. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the such as; the term “example” is used to provide exemplary instances of the item in discussion, not an exhaustive or limiting list thereof; the terms “a” or “an” should be read as meaning “at least one,” “one or more” or the such as; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Hence, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other such as phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

Thus, for example, it will be appreciated by those of ordinary skill in the art that the diagrams, schematics, illustrations, and the such as represent conceptual views or processes illustrating systems and methods in accordance with particular embodiments. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named manufacturer.

1. (canceled)

2. The array of claim 13, wherein at least one of said snap connector components includes a pair of flexible members including protrusions or defining recesses for matching a complementary snap connector component of an adjacent module for snapping together said adjacent modules.

3. The array of claim 2, wherein said snap-lock components are configured to lock said snap connectors of said adjacent modules together in a locked position by inhibiting flexing of said flexible members.

4. The array of claim 3, wherein said flexing is inhibited by one or more slide-lock components occupying areas alongside said flexible members.

5. The array of claim 13, wherein said snap-lock components are rotatable between unlocked and locked positions.

6. The array of claim 13, wherein said snap lock components are slidable between unlocked and locked positions.

7. The array of claim 13, wherein said mounting feet are each snap-coupled to said one of said panel rails.

8-12. (canceled)

13. An array of two or more preassembled solar panel modules, each preassembled solar panel module comprising:
a solar panel configured for receiving and converting solar radiation to produce electrical power;
a plurality of panel rails coupled in preassembly to backside surfaces of said solar panels, including at least two panel rails disposed halfway or more along opposing longest edges of each solar panel;
a plurality of snap connector components coupled to or integrated with the panel rails and protruding from proximate edges of adjacent preassembled solar panel modules at matching locations for snapping together said adjacent modules;
a plurality of snap lock components that are each movable to a locked position to prevent decoupling of said adjacent modules after said snapping together of said adjacent modules; and
one or more mounting feet each coupled both at a selected location to one of the at least two panel rails and at a selected location to a roof or other sunlight receiving surface upon which said array is installed,
wherein 0.42<H/G<15, where H is a height of a preassembled solar panel module measured as a spacing of said backside surface of said preassembled solar panel module from said roof or other sunlight receiving surface, and where G is a gap spacing between nearest edges of adjacent preassembled solar panel modules.

14. The array of claim 13, wherein 0.42<H/G<3.

15. The array of claim 13, wherein 0.42<H/G<1.5.

16. The array of claim 13, wherein 20 mm<G<120 mm.

17. The array of claim 13, wherein 50 mm<H<300 mm.

18. The array of claim 13, wherein H<75 mm and G>37.5 mm.

19. The array of claim 13, wherein H/G≈1.

20.-22. (canceled)

23. An array of two or more preassembled solar panel modules, each preassembled solar panel module comprising:
a solar panel configured for receiving and converting solar radiation to produce electrical power;
a plurality of panel rails coupled in preassembly to backside surfaces of said solar panels, including at least two panel rails disposed halfway or more along opposing longest edges of each solar panel;
a plurality of snap connector components coupled to or integrated with the panel rails and protruding from proximate edges of adjacent preassembled solar panel modules at matching locations for snapping together said adjacent modules;
a plurality of snap lock components that are each movable to a locked position to prevent decoupling of said adjacent modules after said snapping together of said adjacent modules;
one or more mounting feet each coupled both at a selected location to one of the at least two panel rails and at a selected location to a roof or other sunlight receiving surface upon which said array is installed; and
bumpers at corners of said preassembled solar panel modules that extend normally from said backside surface further than any of said plurality of panel rails.

24. The array of claim 23, wherein said bumpers at said corners of said preassembled solar panel modules protrude from said backside surface away from both adjacent edges.

25-29. (canceled)

30. An array of two or more preassembled solar panel modules, each preassembled solar panel module comprising:
a solar panel configured for receiving and converting solar radiation to produce electrical power;
a plurality of panel rails coupled in preassembly to backside surfaces of said solar panels, including at least two panel rails disposed halfway or more along opposing longest edges of each solar panel;
a plurality of snap connector components coupled to or integrated with the panel rails and protruding from proximate edges of adjacent preassembled solar panel modules at matching locations for snapping together said adjacent modules;
a plurality of snap lock components that are each movable to a locked position to prevent decoupling of said adjacent modules after said snapping together of said adjacent modules; and
one or more mounting feet each coupled both at a selected location to one of the at least two panel rails and at a selected location to a roof or other sunlight receiving surface upon which said array is installed; and
one or more toggle anchors each comprising a rotatably-attached, elongated washer for piercing roof sheathing or other sunlight receiving surface material in a first position and rotating to a second position securing the toggle anchor after said piercing.

31-35. (canceled)

36. The array of claim 30, wherein said mounting feet include one or more pivoting features configured to provide relative movement between a pair of components to prevent or reduce strain or stress within the array.

37. The array of claim 30, wherein said mounting feet each include one or more pivoting features configured to provide relative movement of a preassembled solar panel module to prevent or reduce stress or strain from wind or snow loading or other factors by flexing about the one or more pivoting features.

38-41. (canceled)

42. The array of claim 13, wherein the mounting feet include one or more pivoting features configured for relative movement between a pair of pivotably-coupled components to prevent or reduce strain or stress.

43. The array of claim 13, wherein solar panel includes at least two overlapping surfaces that are configured to receive and convert solar radiation to generate electrical power.

44-584. (canceled)
